(19) United States
(12) Patent Application Publication
(10) Pub. No.: US 2005/0273298 A1
(43) Pub. Date: Dec. 8, 2005

(54) Simulation of systems

(75) Inventor: Sunil C. Shah, Los Altos, CA (US)

Correspondence Address: HICKMAN PALERMO TRUONG & BECKER, LLP, 2055 GATEWAY PLACE, SUITE 550, SAN JOSE, CA, 95110, US

(73) Assignee: Xoomsys, Inc.

(21) Appl. No.: 11/204,433

(22) Filed: Aug. 15, 2005

Related U.S. Application Data
(63) Continuation-in-part of application No. 10/850,794, filed on May 21, 2004.
(60) Provisional application No. 60/473,047, filed on May 22, 2003.

(51) Int. Cl. G06F 17/10

(52) U.S. Cl. 703/2

(57) ABSTRACT

According to an embodiment of the invention, a system and method for performing simulations is provided. Using parallelism-in-systems, the method decomposes a larger problem into several smaller partitions. A series of iterations is performed until the waveforms exchanged between the partitions converge. Approximate pre-view solutions of strongly coupled partitions are introduced to reduce the number of iterations required for convergence. These approximate pre-view solutions are introduced before the simulations occur. Once the waveforms converge, the simulation has determined a solution.

### RELATED APPLICATIONS

This application claims priority as a continuation-in-part of U.S. patent application Ser. No. 10/850,794, filed on May 21, 2004, entitled “Method for Simulation of Electronic Circuits and N-Port Systems”, which is incorporated herein by this reference.

This application is related to U.S. provisional application Ser. No. 60/473,047, filed on May 22, 2003, entitled “Method for fast, accurate simulation of electronics circuits and physical n-port system”, which is incorporated herein by this reference.

### FIELD OF THE INVENTION

The current invention generally relates to simulations, and specifically to accurate waveform level computer simulations of large complex systems.

### BACKGROUND

Simulations can be carried out using computer systems so that a designer or developer can test a design before producing it. For example, a designer can design a complex circuit using a computer application. The application can then simulate the output of the circuit at certain times given certain inputs. Using the simulation, the designer can easily prototype several circuits and test them without actually having to build them.

Simulations often require extensive computing resources. One way to provide these resources in an inexpensive manner is to use clusters of machines that operate in parallel. For example, several computer systems can be networked together to collectively work on a solution for a single problem. One challenge of performing these simulations in parallel is dividing and coordinating the work amongst the machines.

Circuit simulations are often performed using the Simulation Program With Integrated Circuit Emphasis (SPICE) simulator or its derivatives. These simulators use a numerical integration known as the “Direct Sparse” solution method. As circuits have become larger and as signal integrity effects have become more important, the time it takes to run these simulations has become prohibitive. These simulations typically involve transient behavior of the circuit and require solving the Initial Value Problem.

FIG. 1 is a flowchart illustrating a process for determining a solution to a simulation using the initial value problem. The process 100 can be used to determine a solution for a given portion of a larger simulation using the direct sparse method. For example, a circuit simulation can be divided into several blocks, each of which can be represented by differential algebraic equations (DAEs). According to one embodiment, the DAEs are provided using a modified nodal analysis (MNA). These equations can then be simplified and solved to reach a solution for the simulation.

The process 100 begins in start block 102. In block 104, the DAEs from the device models are supplied. For example, the DAEs may be of the form F(t, y, \dot{y})=0. In block 106, the Backward Difference formula is applied to the DAEs to obtain finite difference equations. The finite difference equations may be of the form

$$F ( {t}_{n} , {y}_{n} , \frac{{y}_{n} - {y}_{n - 1}}{{h}_{n}} ) = 0.$$

These are non-linear algebraic equations.

Since non-linear equations are difficult and computationally expensive to solve, in block 108, a Newton-Raphson (NR) iteration is performed to obtain linear algebraic equations. The NR iteration is of the form

$${y}_{n}^{m + 1} = {y}_{n}^{m} - {( \frac{\partial F}{h \partial {y}^{′}} + \frac{\partial F}{\partial y} )}^{- 1} F ( {t}_{n} , {y}_{n}^{m} , \frac{{y}_{n}^{m} - {y}_{n - 1}}{{h}_{n}} ) .$$

The resulting linear algebraic equations, of the form Ax=b can then be solved using a linear system solver in block 110.

Blocks 108 and 110 form an NR loop, which can be repeated until the solution of the linear system solver in block 110 converges. In block 112, it is determined whether the NR solution has converged. If it has, the process continues to block 114. If the solution has not converged, the NR loop repeats, and the process returns to block 108.

In block 114, if there are more time steps to be processed, the process 100 returns to block 106, and a solution can be determined for a new point in time. If there are no more time steps, the process finishes in block 116. At that point, a solution for the problem has been obtained.

### Parallelizing Simulations

Verification of chip design requires running many transient simulations with different input waveforms or dynamic vectors. Parallel implementation of simulations can speed up the simulations. Communication overhead and the need to synchronize computations through communications can create bottlenecks in parallel implementations. Direct Sparse methods have provided limited performance gains in parallel implementations because of the communication and synchronization overhead.

The approaches for parallelizing the simulation of systems fall into two general categories, referred to herein as parallelism-in-the-method and parallelism-in-systems. Using a parallelism-in-the-method approach, the NR iterations of the process 100 can be parallelized. However, parallelizing the NR iterations requires communication synchronization across the entire circuit at time scales dictated by activities (i.e., a fast change in variable values) anywhere in the entire circuit.

In the context of circuit-simulations, the parallelism-in-systems approach is also referred to as “waveform relaxation” in the circuit simulation literature. The parallelism-in-systems approach involves partitioning a circuit into sub-circuits, and allows parallel simulation of the Initial Value problem (a time transient simulation) by exchanging entire waveforms across the sub-circuits. However, in most practical circuits, because of feedback, the resulting convergence slows down.

The problem caused by the slowing of the convergence is exacerbated when the sub-circuits used in a parallelism-in-systems simulation are parts of a strongly coupled system. A system, or a portion of a system, comprising of two or more sub-circuits is considered “strongly coupled” (See Kevin Burrage, Parallel Methods for Systems of Ordinary Differential Equations, Advances In Computational Mathematics, 1997, pp 1-31) if two or more nodes in two different sub-ciruits in the system are “tightly coupled” as decribed in (J. White and A. I. Sangiovanni-Vincentelli, Partitioning Algorithms and Parallel Implementation of Waveform Relaxation for Circuit Simulations, Proceedings of ICAS-85, pp. 221-224).

The benefit of parallelism-in-system implementations diminishes as a result of slow convergence, which results in many relaxation iterations. To address this problem, approaches have been proposed for dealing with the slow convergence caused by strong coupling in the context of local couplings. The term “local coupling” refers to loading at a particular connection between two entities. In the context of circuits, a local coupling may correspond to loading the wire that connects one port of one circuit to another port of another circuit. For example, in FIG. 18, the coupling V1 between S1 and S2 constitutes a local coupling.

Some attempts to address the slow convergence problem caused by strong local coupling are described, for example, in J. White and A. I. Sangiovanni-Vincentelli, Partitioning Algorithms and Parallel Implementation of Waveform Relaxation for Circuit Simulations, Proceedings of ICAS-85, pp. 221-224, V. An improved relaxation approach for mixed system analysis with several simulation tools (Dmitriev-Zdorov, V. B.; Klaassen, B. Design Automation Conference, 1995, with EURO-VHDL, Proceedings EURO-DAC '95., European, Vol., Iss., 18-22 Sep. 1995 pp. 274-279).

In contrast to “local coupling”, “global coupling” refers to a coupling formed by connecting multiple entities in a manner that forms a cycle. For example, a global coupling may result from connecting a circuit A to a circuit B, which is connected to a circuit C, which is connected back to circuit A. Thus, in FIG. 18, the coupling that includes V1, V2 and V3, which forms a cyclical connection between S1, S2 and S3, is a global coupling. Some attempts to address “global coupling” are described in, (Generalized coupling as a way to improve the convergence in relaxation-based solvers Dmitriev-Zdorov, V. B. Design Automation Conference, 1996, with EURO-VHDL '96 and Exhibition, Proceedings EURO-DAC '96, European, Vol., Iss., 16-20 Sep. 1996, Pages: 15-20) and in (Parallel Waveform Relaxation of Circuits with Global Feedback Loops, Design Automation Conference, 1992, pp. 12-15) but have suffered from poor efficiency.

In practice, when parallelism-in-system approaches are used to parallelize the simulation of a system, either the partitions become so large that effective parallelization of computation load is not achieved, or the communication and synchronization overheads make the method ineffective. What is needed is a method that reduces the time required for performing parallelized simulations and takes into account both local strong coupling and global strong coupling.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 is a flowchart illustrating a process for determining a solution to a simulation using the initial value problem;

FIG. 2 illustrates a computer system on which an embodiment of the present invention can be implemented;

FIG. 3 illustrates a cluster of computer systems according to an embodiment of the invention;

FIG. 4 is a flowchart describing a process for partitioning a system and performing a simulation according to one embodiment of the invention;

FIG. 5 illustrates a strongly coupled multi-port nonlinear circuit;

FIG. 6 illustrates a strongly coupled circuit including an approximation according to an embodiment of the invention;

FIG. 7 illustrates a large partition decomposed into several smaller partitions;

FIG. 8 illustrates a pre-viewer circuit for the circuit 700 with m approximated partitions;

FIG. 9 illustrates several processors performing simulations for several different partitions;

FIG. 10 illustrates several processors running in parallel according to an embodiment of the invention;

FIG. 11 illustrates a pre-viewer for a strongly coupled circuit similar to the pre-viewer circuit 600;

FIG. 12 illustrates a circuit including many separate partitions similar to the circuit 800;

FIG. 13 illustrates a circuit exhibiting bi-directional local coupling;

FIG. 14 illustrates the slow convergence using a standard Gauss-Seidel decomposition;

FIG. 15 illustrates an approximation for the non-linear element G2;

FIG. 16 illustrates the circuit including a piece-wise linear approximation of the non-linear element G2;

FIG. 17 is a plot illustrating the accelerated convergence of the circuit;

FIG. 18 illustrates a bi-quadratic filter circuit;

FIG. 19 illustrates the circuit partitioned using a Gauss-Seidel decomposition;

FIG. 20 is a plot showing the convergence of a simulation of the circuit using Gauss-Seidel decompositions;

FIG. 21 illustrates a pre-viewer from decomposition of the circuit according to an embodiment of the invention;

FIG. 22 is a graph illustrating the convergence of the circuit decomposed according to an embodiment of the invention;

FIG. 23A illustrates a non-linear two dimensional mesh;

FIGS. 23B and 23C illustrate exploded views of the mesh;

FIG. 24 illustrates a graph showing a center node voltage for a tile from a full reference simulation and from a full order linear approximation of the circuit;

FIG. 25 illustrates the difference between the approximate low order pre-viewer response and the full reference system for a center node voltage of a tile;

FIG. 26 is a graph showing the error of the voltage output of the simulation after three iterations using an embodiment of pre-viewer based approximation;

FIG. 27 is a block diagram of a system for simulating systems, according to an embodiment of the invention;

FIG. 28A is a block diagram of two components (Y and Z) that are connected to each other by one or more wires;

FIG. 28B is a block diagram of the system of FIG. 28A in which components Y and Z have been separated; and

FIG. 29 is a block diagram in which a system has been partitioned into three distinct “Y” partitions, and three distinct “Z” partitions.

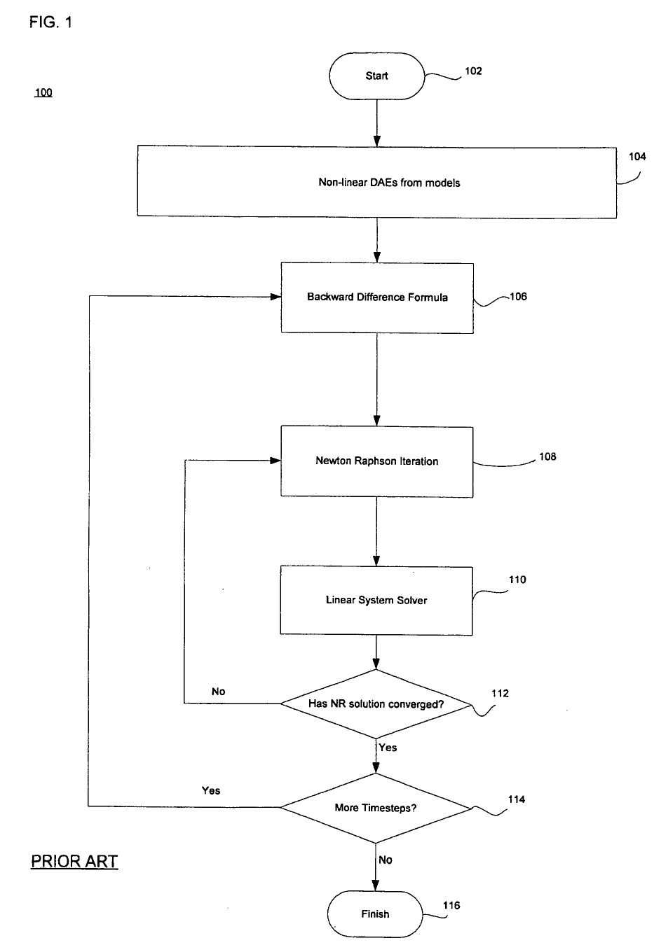

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Terminology

Note that in this description, references to “one embodiment” or “an embodiment” mean that the feature being referred to is included in at least one embodiment of the present invention. Further, separate references to “one embodiment” or “an embodiment” in this description do not necessarily refer to the same embodiment; however, such embodiments are also not mutually exclusive unless so stated, and except as will be readily apparent to those skilled in the art from the description. For example, a feature, structure, act, etc. described in one embodiment may also be included in other embodiments. Thus, the present invention can include a variety of combinations and/or integrations of the embodiments described herein.

### Overview

As mentioned above, parallelism-in-systems involves decomposing a system into several partitions. The smaller partitions can more easily be parallelized, thereby potentially reducing the time required for the simulation. In addition, the smaller partitions also require fewer total computations. Generally, simulations are parallelized by exchanging waveforms between the partitions. The waveforms represent outputs and inputs of specific partitions. The waveforms converge once the waveforms being exchanged approach a common value, resulting in a solution. Strong coupling between two partitions can increase the number of iterations (or exchanges of the waveforms between the two partitions) required for convergence.

Prior implementations of the simulation-in-systems approach were only able to deal effectively with local strong coupling. Techniques are described herein for reducing the number of iterations required for convergence by performing approximate “pre-view” solutions of strongly coupled partitions. These pre-view solutions are introduced before the simulations begin, to reduce the effects of both local and global coupling. Once the waveforms converge, the simulation has determined a solution. As will be explained below, the introduction of the approximation reduces the amount of computational time required for the waveforms to converge, and accounts for both local and global strong coupling.

### Overview of Simulation Iterations

Techniques are provided for simulating a system in parallel using a series of simulation iterations. According to one embodiment, the system is divided into partitions. After dividing the system into partitions, one or more of the partitions are selected to be approximated and separately simulated. The partitions that are selected to be approximated and separately simulated are referred to herein as the “selected partitions”. The parts of the system that do not belong to any selected partition are collectively referred to herein as the system's “remainder”.

After the set of selected partitions is established, a simulation iteration is executed. Each simulation iteration involves two simulation phases: a pre-viewer simulation phase and a selected partition simulation phase. During the pre-viewer simulation phase, a simulation of the system is run during which the selected partitions of the system are simulated using a relatively less-precise simulation mechanism. During the selected partition simulation phase, a set of simulations are run during which each of the selected partitions is simulated using a relatively more-precise simulation mechanism.

The results from the pre-viewer simulation phase are compared to the results from the selected partition simulation phase to determine whether additional simulation iterations are required. If additional simulation iterations are required, then addition simulation iterations are performed, where each subsequent simulation iteration takes into account the results of the previous simulation iteration.

According to one embodiment, a relatively less-precise mathematical model of the selected partitions is used during the pre-viewer simulation phase, and a relatively more-precise mathematical model of the selected partitions is used during the selected partition simulation phase. In such an embodiment, the same simulator may be used to simulate the selected partitions during both phases of the simulation iteration.

According to another embodiment, a relatively less-precise simulator is used to simulate the selected partitions during the pre-viewer simulation phase, and a relatively more-precise simulator is used to simulate the selected partitions during the selected partitions simulation phase. In such an embodiment, the same mathematical model of the selected partitions may be used during both phases of the simulation iteration.

### Overview of Simulation System

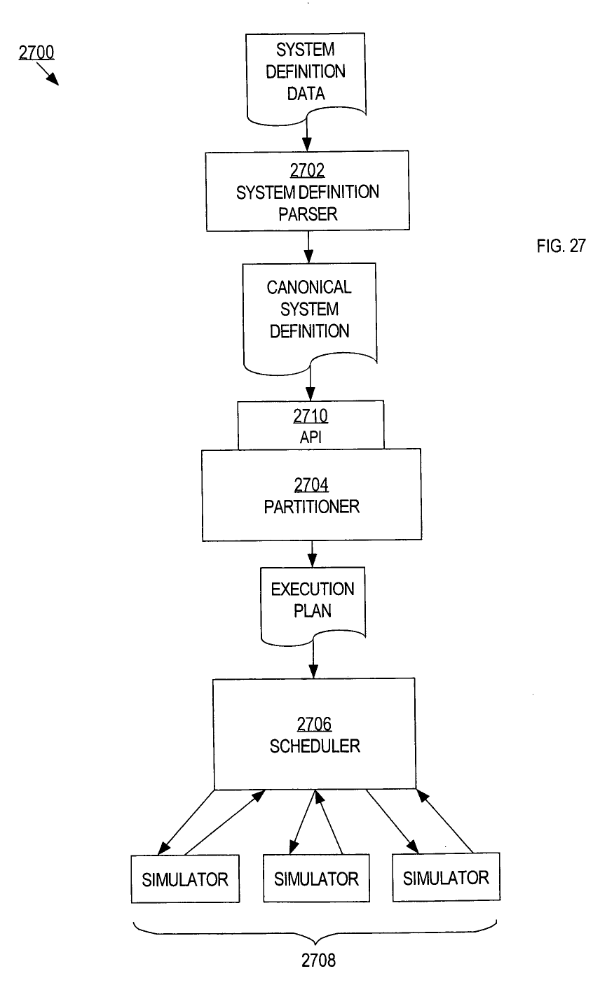

FIG. 27 is a block diagram of a system 2700 for simulating systems, according to an embodiment of the invention. System 2700 generally includes a system definition parser 2702, a partitioner 2704, and a scheduler 2706.

System definition parser 2702 receives the definition of the system to be simulated, and presents a canonical description of that system to an API 2706 of partitioner 2704. System 2700 may include several different system definition parsers, each of which is designed to parse a different type of system definition. For example, if the system to be simulated is a circuit, then a system definition parser 2702, may be employed that is able to parse a net list that describes the circuit. After parsing the net-list, the system definition parser 2702 would present a canonical description of the circuit to partitioner 2704.

Though the use of different system definition parsers, partitioner 2704 is able to be used with a variety of types of systems. Because those system definition parsers present canonical descriptions of the systems to partitioner 2704, the specific nature of systems to be simulated may be largely transparent to the partitioner 2704.

Partitioner 2704 divides the to-be-simulated system into partitions. As shall be described in greater detail below, the process of partitioning the to-be-simulated system may involve several phases. Once the to-be-simulated system is partitioned, partitioner generates a plan that indicates how the system will be simulated. This plan, referred to herein as the “execution plan” of the simulation, is then provided to scheduler 2706.

Scheduler 2706 receives the execution plan for the simulation from partitioner 2704, and executes the plan. Typically, execution of the plan involves supplying stimuli and simulation problems for simulators, invoking simulators 2708, and receiving simulation results from the simulators 2708. In the context of circuit simulation, simulators 2708 may include SPICE and/or FAST SPICE simulators. As shall be described in greater detail hereafter, during certain phases of the simulation, scheduler 2706 causes multiple simulators 2708 to perform simulations in parallel, where the parallel operations correspond to the partitions into which the to-be-simulated system was divided.

### Simulation of N-Port Systems

Although circuit simulations will be discussed extensively, it is understood that other simulations may benefit from the techniques described herein. For example, biological, chemical, and automotive simulations can be described in terms of networked n-ports.

An n-port may be thought of as a partition of a larger system that can be networked with other systems. Any type of system that can be described in terms of n-ports can benefit from the disclosed techniques. For example, n-ports can describe values such as temperatures, velocity, force, power, etc. Several simulation standards, such as Verilog AMS, are now able to describe various systems in terms of n-ports.

### Partitioning an N-Port System

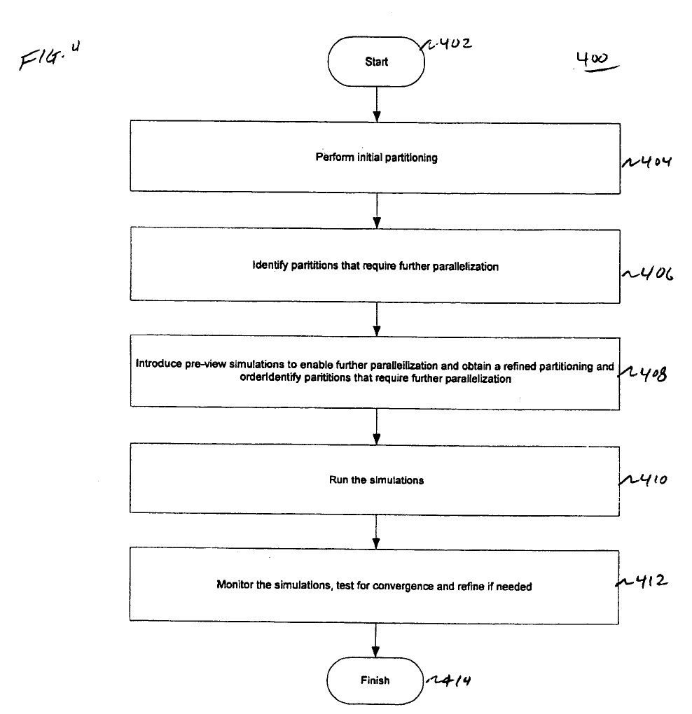

FIG. 4 is a flowchart describing a process for partitioning a system comprising n-ports or circuits and performing a simulation according to one embodiment of the invention. The process 400 describes dividing a larger system to be simulated into smaller partitions to be used with the parallel in systems method. As will be discussed below, by dividing the overall system into smaller blocks, the number of nodes N for each partition is reduced, and as a result, the total number of computations required is reduced. The computations consist of running waveform simulations of each partition for the number of waveform iterations required for convergence.

Large partitions, or those having many unknown node variables, typically require more computation during a waveform simulation than smaller partitions. For most purely digital circuits with no signal integrity effects, the computation costs per time point scale with the number of nodes N, roughly as N^{α}, where a ranges from 1.4 to 1.6. However, when signal integrity effects such as power grid mesh are included, α can be range from 1.8 to 2.4. In addition, for larger circuits the number of time points in the simulation is greater because of higher total activity. Together, these effects strongly favor running smaller partitions, provided the convergence rate and overheads are not adversely affected.

Generally, the fewer nodes or variables N a circuit has, the fewer computations that are required per time point. For example, in a system with α=2, a partition having 1000 nodes will require ˜1,000,000 floating point operations per time point in a waveform. On the other hand, if the 1000 node circuit is divided into 10 smaller circuits of 100 nodes each, each of those ten smaller circuits will only require ˜10,000 floating point operations per time point, for a total of ˜100,000 operations per time point In addition, for larger circuits the number of time points in the simulation are higher because of higher total activity.

The effects of strong coupling are balanced against the advantages of dividing the system into smaller and smaller partitions. For example, a partition may comprise a circuit that includes elements whose behavior depends heavily on the behavior of other elements of the circuit. If the partitioning divides these strongly coupled partitions, the resulting simulation typically will require many waveform iterations to converge. As a result, the increased number of iterations needed for convergence may outweigh the reduction in time required for simulating each waveform iteration because of the smaller partitions. The introduction of an approximation using the pre-viewer, as described below, reduces the effects of both global and local coupling, reducing the number of iterations required for convergence.

The process 400 begins in start block 402. In block 404, an initial partitioning of the full system into subsystems is created. This partitioning is completed based on weak coupling arising from inherent properties of the system. Effectively, the full system is scanned to determine a number of initial partitions and their order of simulation. These partitions are chosen so that they converge in relatively few iterations when simulated in the order of inherent coupling. Large initial partitions are the result of strong coupling within. As mentioned above, larger partitions require significantly more computation time for each waveform simulation. The longer time creates imbalance in computer loading which limits parallelization. In block 406, ordered partitions that require further parallelization are identified. These partitions are identified by examining the partitions generated in block 404 as being further divisible. The identified partitions are strongly coupled partitions that are larger than would be desired. In block 408, pre-viewer simulations are introduced to enable further parallelization and obtain a refined partitioning and order. The pre-viewer and its operation will be explained further below, but generally the pre-viewer comprises the approximation that will be introduced into a strongly coupled system to provide an approximate pre-view solution. The pre-viewer “pre-views” a solution to the simulator. Since the pre-viewer generates an approximation before the simulation of partitions begins, the system reduces the effects of local and global coupling, which will be explained below.

The pre-viewer determines the best candidates for further division. In block 410, the refined partition simulations are run, including the pre-viewer simulations in the new order on the computer platform. This operation is the performance of the simulation itself. The simulation may be performed using SPICE, Verilog AMS, or another simulation application.

In block 412, the progress of the simulation is monitored, and a test for convergence of the proposed divisions is performed. If needed, the divisions are further refined to produce the best set of blocks, and therefore the best simulation.

Simulation of dynamical systems arising in areas such as circuit simulation are typically described using an interconnection of n-ports. Simulation languages such as Verilog AMS enable designers to describe large scale systems hierarchically in terms of n-ports. Circuit simulators such as SPICE permit hierarchical description in terms of n-port sub-circuits. Any n+1 terminal device can be described as an n-port sub-circuit. Each n-port is internally described as a set of differential and algebraic equations. Interconnections at ports result in further constraints such as Kirchoff's Current Law (KCL) or Kirchoff's Voltage Law (KVL).

### Example of Partitioning a Circuit

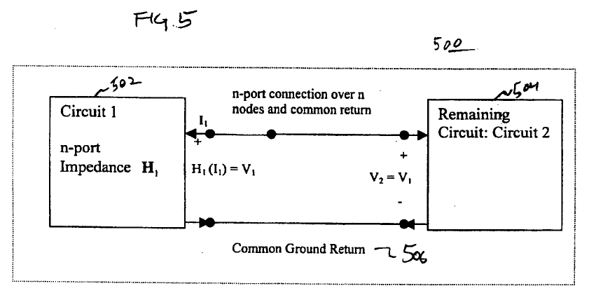

FIG. 5 illustrates a strongly coupled multi-port nonlinear circuit. The circuit 500 includes circuits 502 and 504, which may be described as individual n-ports. The circuit 500 is the result of partitioning 404 described above. The circuit 500 may be a partition that is too large, and will therefore increase the time required for the simulation. However, the circuit 500 is also strongly coupled, and if divided, will converge too slowly. The larger circuit 500 may be preliminarily divided into the two circuits 502 and 504, where the circuit 502 can be approximated, and the circuit 504 is the remainder of the original circuit 500.

Specifically, circuit 500 has been divided into two partitions: circuit 502 and circuit 504. For the purpose of illustration, it shall be assumed that circuit 502 is the only partition that is selected to be approximated and separately simulated. Thus, circuit 502 is the “selected partition” of circuit 500, and circuit 504 is the “remainder”.

Assume that the circuit 502 has been represented as an n-port Impedance H₁ and the circuit 504 is the remainder of the larger partition 500. The circuit 502 may be an n+1 terminal circuit, where n is the number of ports found in the circuit and where the circuit 502 shares a common ground 406 with the remainder of the circuit 504.

If the circuit 500 is transformed by introducing a computationally cheap approximation in place of the circuit 502, say Ĥ₁, the convergence can be accelerated.

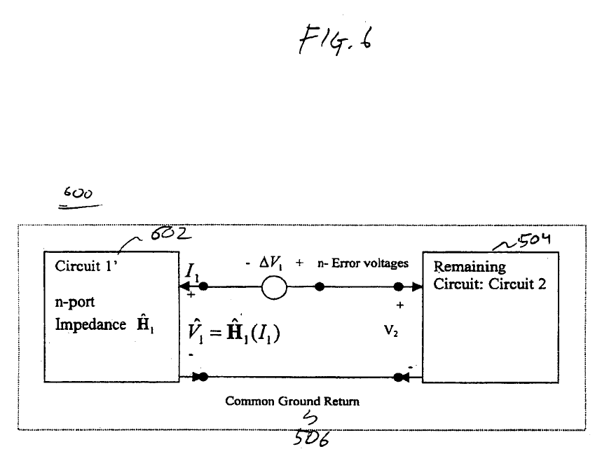

FIG. 6 illustrates a strongly coupled circuit 600 including an approximation according to an embodiment of the invention. The circuit 600 is a “pre-viewer” of circuit 500, in which the circuit 502 (the selected partition) has been replaced with an approximation circuit 602. The remaining circuit 504 is the same as above. As long as the approximation Ĥ₁ is reasonable as described later, the pre-viewer circuit 600 becomes weakly coupled to the original circuit partition 502 H₁, and the convergence of the pre-viewer circuit 600 and the circuit 502 will occur much more quickly. The approximation Ĥ₁ is chosen to be computationally inexpensive so that the pre-viewer circuit 600 simulation takes about the same as time as the simulation of partition H₂ and that of partition 502 H₁.

### Parallel Execution

After partitioning a to-be-simulated system, partitioner 2704 constructs a parallel execution plan for the simulation. Partitioner 2704 passes the parallel execution plan to scheduler 2706, and scheduler 2706 invokes the simulators 2708 based on the plan. For example, during the pre-viewer simulation phase of a simulation iteration, scheduler 2706 may invoke a simulator to simulate a pre-viewer of the to-be-simulated system. During the selected partitions simulation phase of a simulation iteration, scheduler 2706 may invoke a separate simulator for each of the selected partitions of the to-be-simulated system. The results of each simulation iteration are used to determine whether additional simulation iterations should be performed.

According to one embodiment, while the to-be-simulated system is simulated in this manner, the simulation performance is monitored. If a simulation is taking significantly longer to execute than the cost estimate indicated, then the simulation may be halted. After the simulation is halted, partitioner 2704 may revise the partitioning used in the simulation. For example, partitioner 2704 may further decompose a partition of the system upon detecting that simulation of that partition is taking significantly longer than originally estimated. After the partitioning has been changed, a new execution plan may be generated based on the new partitioning scheme. The new execution plan is passed to the scheduler 2706, which restarts the simulation based on the new execution plan.

For example, partitioner 2704 may partition a particular system until all partitions of the system have an estimated simulation cost that is equal to or less than X. During the actual simulation, the system 2700 may detect that simulation of one of the partitions is costing significantly more than X. At that point, the system 2700 may halt the simulation, and further decompose that particular partition into smaller partitions. The system 2700 may then restart the simulation process, using an execution plan that is based on the smaller partitions.

Rather than restarting the entire simulation process, partitions that are determined to be “too large” may be further decomposed on-the-fly. Thus, during one simulation iteration, a particular partition may be simulated. Between simulation iterations, that particular partition may have been divided into several smaller partitions. Consequently, during a subsequent simulation iteration, each of the smaller partitions is separately simulated.

In one embodiment, one or more “characterization runs” are performed by system 2700 before selecting a “final” execution plan. During the characterization runs, test simulations are performed on the partitions, to determine which partitions, if any, should be further decomposed.

### Example of Parallel Simulation

Once circuit 500 has been partitioned, and a pre-viewer circuit 600 has been created, the pre-viewer circuit 600 may be used to simulate the circuit 500 during the pre-viewer simulation phase of circuit 500.

Because simulating pre-viewer circuit 600 involves performing a less-precise simulation of partition 502, the simulation of pre-viewer circuit 600 may be performed much faster than the simulation of circuit 500.

The results produced by simulating circuit 600 may be less accurate than those produced by directly simulating circuit 500. However, by performing multiple simulation iterations, accurate simulation results can be produced.

The waveform iterations for the simulation are described below:
1) k=1; Initialize waveforms ΔV₁^{k-1}=0
2) ΔV₁^{k-1} [symbol] {I₁^{k}, \hat{V}₁^{k}} by simulating the pre-viewer circuit 600,
3) I₁^{k} [symbol] V₁^{k} by simulating the partitioned standalone impedance circuit 502 H₁, giving the voltage waveforms ΔV₁^{k}=V₁^{k}−\hat{V}₁^{k}
4) if ∥ΔV₁^{k-1}−ΔV₁^{k}∥>tol then k=k+1, go back to operation 2) otherwise end. The value k is incremented for each iteration. In the first operation 1) variables are initialized.

The second operation 2) represents the pre-viewer simulation phase during which the pre-viewer circuit 600 is used to determine ΔV₁^{k-1} [symbol] {I₁^{k}, \hat{V}₁^{k}}. The value ΔV₁^{k-1} corresponds to the difference between the actual voltage waveforms and the approximate voltage waveforms for the previous iteration k−1. This value is inputted into the circuit 600, a simulation is run, and the values for the current waveforms and an approximation of the voltage waveforms for this iteration are determined using the pre-viewer.

The third operation 3) constitutes the selected partition simulation phase, during which the determined value for the current waveforms is input into circuit 502 (the selected partition) to determine a value for the voltage waveforms for this iteration.

The difference between the actual and the approximate value for this iteration Δ·V₁^{k} can then be determined. In the fourth operation 4), if the norm of the difference between waveforms ΔV₁^{k-1} and ΔV₁^{k} is greater than a predetermined tolerance, then the iterations continue, and the process returns to the operation 2). If the difference is less than the tolerance, the waveforms have converged, and the simulated values of the circuit 602 have been determined. Computation of the norm of the waveforms and the choice of approximation in the pre-viewer will be described further below.

### Example Simulation with Multiple Selected Partitions

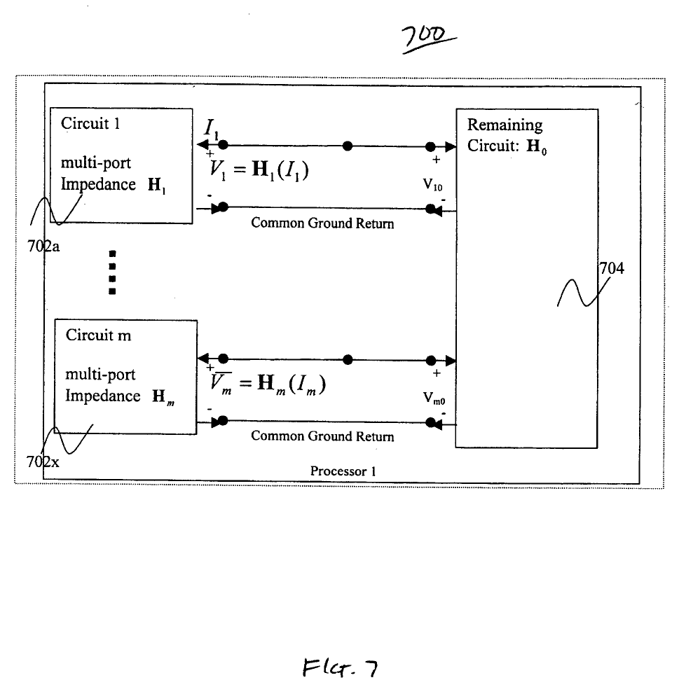

In the example given above, a single sub-circuit (circuit 502) was used as a “selected partition” during the simulation of circuit 500. In some cases, it may be necessary to introduce several approximations into a single partition. FIG. 7 illustrates a large partition decomposed into several smaller partitions. As illustrated in FIG. 7, the circuit 700 is a large partition remaining from an initial partitioning. The circuit 700 is strongly coupled, so it has been divided into several subcircuits 702a-702x, where x is an arbitrary number of partitions equal to the m approximated partitions. The subcircuits 702a-702x are all coupled to the remainder of the circuit 700 H₀ 704, which typically comprises simple passive elements such as resistors. FIG. 8 illustrates a pre-viewer circuit 800 for the circuit 700 with m approximated partitions. The subcircuits 702a-702x each have been replaced by an approximation Ĥ₁ through Ĥₘ 802a through 802x. The remainder circuit H₀ 804 is the same as the remainder 704.

The waveform iterations for convergence of the circuit 800 proceed as:
1) Initialize k=1. Waveforms ΔVᵢ⁰=0 for i=1, . . . m
2) ΔVᵢ^{k-1} [symbol] {Iᵢ^{k}, \hat{V}ᵢ^{k}} by simulating the pre-viewer 800. 704-(802a . . . 802x).
3) Iᵢ^{k} [symbol] Vᵢ^{k} by simulating each of the partitioned standalone Impedance multi-port Circuit Vᵢ^{k}=Hᵢ(Iᵢ^{k}), i=1, . . . m, gives waveforms ΔVᵢ^{k}=Vᵢ^{k}−\hat{V}ᵢ^{k}. This operation can be done in parallel.
4) if ∥ΔVᵢ^{k-1}−ΔVᵢ^{k}∥>tol for any i=1, . . . m then k=k+1, go back to operation 2), otherwise end.

This process is similar to the process described above regarding FIG. 6. In this case, however, there are several different partitions for which simulations must be performed. The value i is incremented for each partition.

### Parallelizing the Selected Partition Simulation Phase

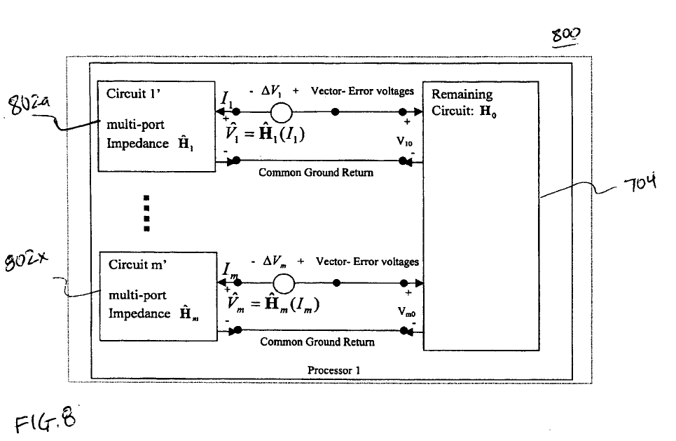

During the selected partition simulation phase, simulations are run on each of the selected partitions. According to one embodiment, the simulations performed during the selected partition simulation phase are executed in parallel. FIG. 9 illustrates several processors performing simulations for several different selected partitions. As shown in FIG. 9, the third operation 3) can be parallelized, by running a simulation of each original partition 902a-902x on a separate processor 904a-904x once the current waveforms Iᵢ^{k} are available from the pre-viewer in the second operation 2). Otherwise, the process is the same as explained above regarding FIG. 6.

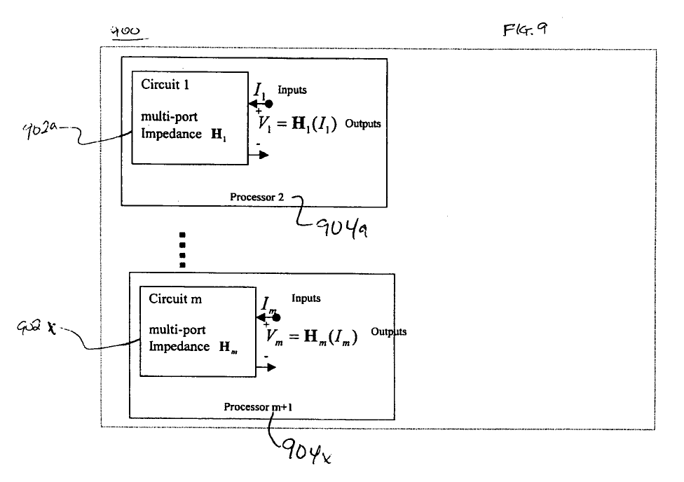

As mentioned above, the third operation 3) can be parallelized but follows serially after the second operation 2). When the computation cost of the composite approximation is less than that of each individual circuit partition Vᵢ^{k}=Hᵢ(Iᵢ^{k}), further parallelization of the second and third operations 2) and 3) can be achieved. FIG. 10 illustrates several processors running in parallel according to an embodiment of the invention. In one embodiment, the several partitions are chosen so that each partition requires approximately the same amount of computation time for the simulation.

FIG. 10 illustrates the actions of several processors 1002, 1004, and 1006 along a timeline 1008 while parallelizing the simulation process described above. The time tₛᵢₘ is the time for each iteration of the simulation. The simulation interval during an iteration is divided in to time segments. FIG. 10 illustrates an example with two time segments each requiring equal computation time tₛᵢₘ/2. The first processor 1002 is generally assigned the calculation of the pre-viewer. The second and third processors 1004 and 1006 are assigned individual partitions, and simulate these partitions. In this example, the first processor 1002 runs the composite approximation (pre-viewer), the second processor 1004 runs the first partition 902a and the third processor 1006 runs the second partition 902b. For example, the first processor 1002 runs a composite approximation 1012 during the first half of the iteration 1010a. When the approximation 1012 is complete, it is transferred to the processors 1004 and 1006, where each processor 1004 and 1006 simulates an individual partition during the second half of the iteration. In other words, during the period of time between to and t₀+tₛᵢₘ/2, the first processor 1002 is calculating the pre-viewer 1012, which will be used by the processors 1004 and 1006 to run their simulations 1014 and 1016, respectively. In the time period between t₀+tₛᵢₘ/2 and t₀+tₛᵢₘ, the first processor 1002 will calculate the pre-viewer simulation of the second half of the first iteration. During this time, the processors 1004 and 1006 run the simulations for the first half of the iteration, using the pre-viewer generated by the processor 1002 during the time t₀ and t₀+tₛᵢₘ/2. Between the time t₀+tₛᵢₘ and t₀+1.5*tₛᵢₘ, the processors 1004 and 1006 run simulations 1018 and 1020 using the pre-viewer solution 1022 generated by the processor 1002 during the time t₀+tₛᵢₘ/2 and t₀+tₛᵢₘ. This process continues until the simulations have converged.

More specifically, at the end of first half of the simulation interval 1010, port current waveforms Iᵢ¹,i=1,2 for the first half interval of the iteration 1010a become available to the processor 1002. These current waveforms are transferred to the processors 1004 and 1006 assigned to run the standalone partitions. Standalone partitions begin their simulations for the first half interval while the processor 1002 runs a simulation for the second half of the simulation interval. When the processors 1004 and 1006 complete simulations of the first half of interval at time t₀+tₛᵢₘ, they provide the voltage waveforms Vᵢ¹,i=1,2 from the partitions for the first half interval to the composite approximation on the processor 1002 to be used during the next iteration. This allows the processor 1002 at time t₀+tₛᵢₘ to proceed with the simulation of the first half interval for the second iteration. The pipelined evaluation enables efficient parallel execution of the method.

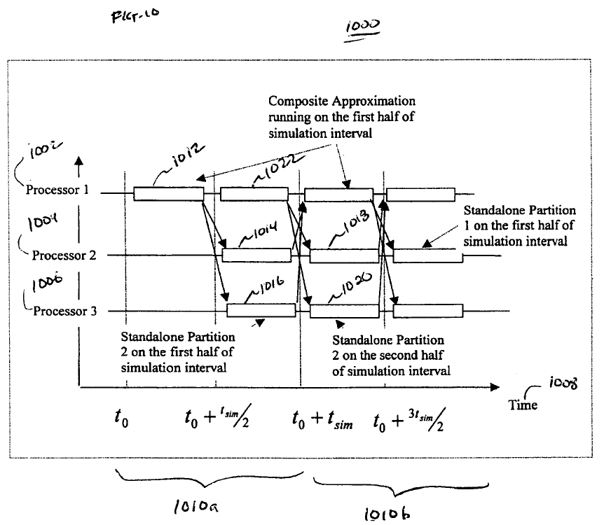

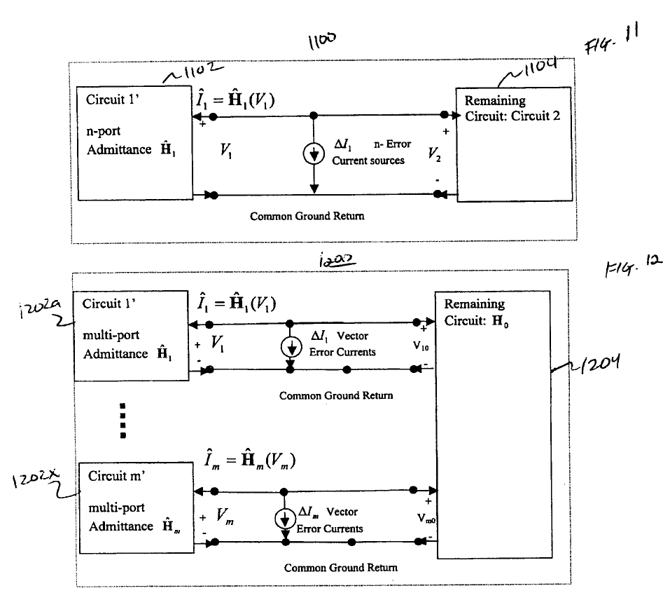

FIGS. 11 and 12 illustrate an embodiment of the invention using admittances and currents rather than impedances and voltages. FIG. 11 illustrates a pre-viewer 1100 for a strongly coupled circuit similar to the pre-viewer circuit 600. The circuit 1100 includes an approximation circuit 1102 and the remainder of the circuit 1104. FIG. 12 illustrates a circuit 1200 including many separate partitions similar to the circuit 800. The circuit 1200 includes several partitions 1202a-1202x, and the remainder of the circuit 1204. Similar to the impedance and voltage n-ports described above, the waveform iterations proceed as follows:
1) Initialize k=1. Waveforms ΔIᵢ⁰=0 for i=1, . . . m
2) ΔIᵢ^{k-1} [symbol] {Vᵢ^{k}, Îᵢ^{k}} by simulating the pre-viewer system 0-1′ . . . m′ as shown in FIG. 11 above.
3) Vᵢ^{k} [symbol] Iᵢ^{k} by simulating each of the partitioned standalone Admittance Multi-port Circuit Iᵢ^{k}=Hᵢ(Vᵢ^{k}), i=1, . . . m, gives waveforms Δ_{I}ᵢ^{k}=Iᵢ^{k}−Îᵢ^{k}. This operation can be done in parallel.
4) if ∥ΔIᵢ^{k-1}−ΔIᵢ^{k}∥>tol for any i=1, . . . m then k=k+1, go back to operation 2) otherwise end
   As used here, i=1 for the first partition 1202a, and i=m for the last partition 1202x. As before, waveforms ΔIᵢ^{k} measure the difference between the actual calculated value of the current and the approximated value. In the fourth operation 4), if the norm of difference between the waveforms ΔIᵢ^{k} of the previous iteration and the current iteration is less than the tolerance tol, the iterations have converged, and the simulation for this partition is complete. In FIG. 8 and FIG. 12 any one n-port can be a hybrid multi-port. The corresponding inputs and outputs are a hybrid (combination) of voltages and currents. The waveform iterations are modified for the appropriate input and output waveforms for the circuits.

### Simulation Benefits

There are several advantages to this approach. Because a generally strongly coupled non-linear multi-port system is considered, both global and local feedback situations are addressed together. Previous methods attempted to address local feedback arising from loading at a single terminal separately from global feedback. These prior methods exploited the specific uni-directional structure of MOS circuits. In the presence of strong local bi-directional coupling this led to convergence difficulties. Prior methods also suffered from slow convergence in the presence of strong global coupling.

The present method applies to any simulation that maps a non-linear waveform to a non-linear waveform in a Banach space. The corresponding Banach space norm is used in convergence test during iterations and for computing incremental operator gains for approximations below. Therefore, it does not use specific structure of the multi-port system to derive its benefits. Any simulator that exploits structure of the underlying domain can be used to exploit the structure in addition to the benefits derived from this method. For example, in circuit simulators such as SPICE, a sparsity structure of the underlying circuit equations is exploited by the simulator itself. Using SPICE in simulating individual components allows exploitation of sparsity structure of the circuit equations.

Composite approximations can be simulated using a variety of approaches. For example, in MOS circuit simulators, a composite approximation can be constructed using table driven piece-wise approximate models in an event driven simulation. Such simulators, also referred to as fast timing simulators, provide approximate waveforms at speeds of 10-1000 times faster than SPICE. However, the approximate waveforms are accurate only to within 5-10%. Another example of an approximate simulation is using Model Order Reduction (MOR). For large RLC networks, MOR provides orders of magnitude faster computations at the expense of introducing errors up to 10%.

Any domain specific simulators and domain specific approximation can be used, provided the approximation meets conditions for convergence. What is remarkable is that rather crude approximations lead to fast convergence.

### Choosing an Approximation

The following description describes the process of choosing an approximation that will be used in the processes above. A pre-viewer for a strongly coupled system comprises a composite approximation having the following properties:
1) The pre-viewer can be simulated in its own simulator in a time comparable to the time required to accurately simulate each original component n-port. This was explained above regarding the pipelined process in FIG. 10.
2) The remaining circuit H₀ is trivial, typically comprising passive devices such as resistors or nodes.
3) Each approximated component n-port Ĥᵢ meets an error test with respect to Hᵢ. This is a test for incremental operator gain of Hᵢ−Ĥᵢ.

Candidates for approximation include simulations with simplified table look up models, switch level simulations, macro models, and reduced order models. These approximations may involve pre-characterization for re-used components. Additionally, there is a tradeoff between quality of the approximation and its run-time speed. At the time of pre-characterization the error between Hᵢ and Ĥᵢ is computed using the following:
Let u₁,u₂, . . . , uₗ be distinct input vectors used in fitting Ĥᵢ.
Let y₁,y₂, . . . , yₗ be the output vectors from running Hᵢ with the inputs: yⱼ=Hᵢ(uⱼ)
Let ŷ₁, ŷ₂, . . . , ŷₗ be the output vectors from running Ĥᵢ with the inputs: ŷᵢ=Ĥᵢ(uⱼ)
Here, uⱼ represents input waveform values, yⱼ=Hᵢ(uⱼ) represents actual waveform output of the partition Hᵢ given the input uⱼ, and ŷⱼ=Ĥᵢ(uⱼ) represents approximate outputs for the partition given the input uⱼ. To determine an error for the approximation, an estimate of the incremental operator gain is computed:

$${\hat{γ}}_{i} = {max}_{j , {j}^{′}} \frac{‖ ( {y}_{j} - {\hat{y}}_{j} ) - ( {y}_{{j}^{′}} - {\hat{y}}_{{j}^{′}} ) ‖}{‖ ( {u}_{j} - {u}_{{j}^{′}} ) ‖}$$

where the norm of the input or output vector waveform is:

$$‖ y ‖ = {( {\int }_{0}^{T} {\vert y ( t ) \vert}^{2} ⅆ t )}^{1 / 2}$$

At any given time t, y(t) is a vector of voltage or current variables. |y(t)| denotes a norm in the linear space of ordered real n-tuples. For example, if y(t) is composed of four voltages, y(t)=[V1(t), V2(t), V3(t), V4(t)], then |y(t)|=max[abs(V1(t)), abs(V2(t)), abs(V3(t)), abs(V4(t))], or alternately |y(t)=(V1²(t)+V2²(t)+V3²(t)+V4²(t)^{1/2}.

In alternate embodiments, for linear operators,

$${\hat{γ}}_{i} = {max}_{ω} {σ}^{2} \{ {H}_{i} ( ω ) - {\hat{H}}_{i} ( ω ) \} ; i . e .$$

the H_{∞}-norm. Standard software such as MATLAB (from Mathworks) also provide tools for computing it. If a component is mildly non-linear, a linearized version of the operator may be used in computing the H_{∞}-norm.

In alternate embodiments other function space norms such as Lₙ^{∞}-norm can be used. In that case, consistent incremental operator gains \hat{γ}ᵢ have to be computed. According to one embodiment of the invention, \hat{γ}ᵢ should be as small as possible to achieve good approximations. A number of potential candidate approximations can be considered, Ĥᵢ_{ⱼ}, j=1,2, . . . n of a sub-system Hᵢ. Assume that all of the allow meeting pre-viewer run-time constraint. Then, the system chooses the approximation with the lowest \hat{γ}ᵢ.

The remaining description describes several examples of the techniques described herein. These descriptions are understood to be examples, and it is further understood that there are several other possible implementations and embodiments of the described invention.

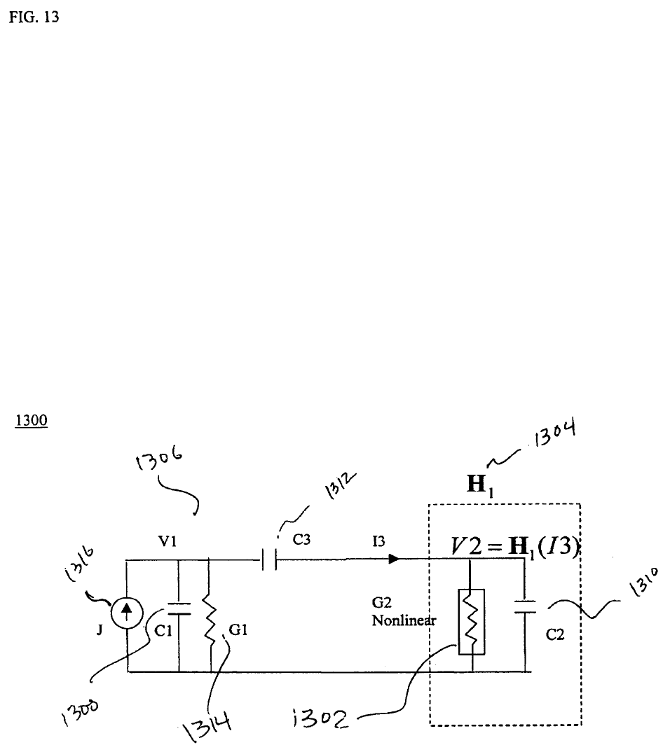

FIGS. 13-17 illustrate the simulation of a circuit exhibiting bi-directional local coupling according to an embodiment of the invention. FIG. 13 illustrates a circuit exhibiting bi-directional local coupling. The circuit 1300 is a strongly coupled circuit that includes a non linear element G2 1302 that can be described by two parallel diode equations: i₂=g2*v₂+I₀*(e^{v}^{₂}^{/Φ}^{_{T}}−e^{(V}^{_{T}}^{-v}^{₂}^{)/Φ}^{_{T}}). The circuit 1300 will be partitioned into a first partition 1304 designated H₁, and the remainder of the circuit 1306. The circuit 1300 also includes three capacitors C1 1308, C2 1310, and C3 1312, a linear element G1 1314, and a current source J 1316.

Standard nodal analysis (using Kirchoff's current law) gives the two coupled differential equations:

$$( C1 + C2 ) * {\dot{v}}_{1} - C3 * {\dot{v}}_{2} + G1 * {v}_{1} = J$$

$${v}_{1} ( 0 ) = v1 \\ ( C3 + C2 ) * {\dot{v}}_{2} - C3 * {\dot{v}}_{1} + {i}_{2} ( {v}_{2} ) = 0$$

$${v}_{2} ( 0 ) = v2$$

Previous methods for decomposing this circuit into partitions using Gauss-Seidel iterations results in the following equations:

$$( C1 + C2 ) * {\dot{v}}_{1}^{k} - C3 * {\dot{v}}_{2}^{k - 1} + G1 * {v}_{1}^{k} = J$$

$${v}_{1}^{k} ( 0 ) = v1 \\ ( C3 + C2 ) * {\dot{v}}_{2}^{k} - C3 * {\dot{v}}_{1}^{k} + {i}_{2} ( {v}_{2}^{k} ) = 0$$

$${v}_{2}^{k} ( 0 ) = v2$$

Note that each differential equation can be solved separately using \dot{v}^{k-1}₂, \dot{v+EE^{k}₁ respectively as sources through the coupling capacitor C3 1312. The terms C3 *v}^{k-1}₂,C3*\dot{v}^{k}₁ represent an approximation of the loading effect from the other circuit.

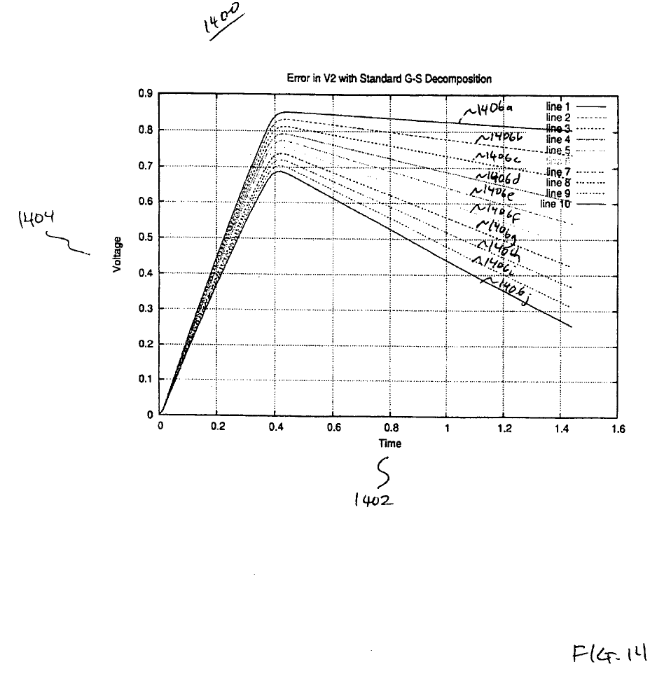

When the coupling capacitor C3 1310 has a large capacitance compared to the other capacitors C1 1308 and C2 1310, the rate of convergence is slow. FIG. 14 illustrates the slow convergence using a standard Gauss-Seidel decomposition. The graph 1400 has time plotted along the x-axis 1402, and voltage along the y-axis 1404. Each of the plot lines 1406 illustrates an error for each progressive iteration of the simulation using the prior Gauss-Seidel decomposition compared to an actual value for the circuit 1300. The graph 1400 shows the simulation slowly converging through ten iterations. The plot line 1406a shows the error for the first iteration, and the plot line 1406j shows the error for the tenth iteration. Although the simulation is slowly converging toward the correct solution, even after the tenth iteration the error exceeds 0.6V at some timepoints. It is clear that such low convergence rates would be unacceptable in practice. Heuristic partitioning algorithms using the prior method would not partition the circuit 1300. However, doing so in larger circuits leads to insufficient granularity for parallel computation.

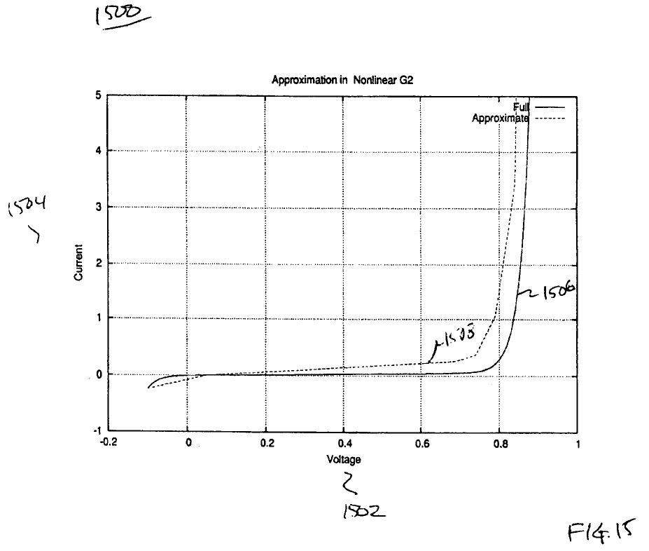

FIG. 15 illustrates an approximation for the non-linear element G2 1302. The graph 1500 shows a plot of voltage on the x-axis 1502 versus current on the y-axis 1504. The full, simulated plot 1506 is shown in the graph 1500. The approximated value is shown using the plot 1508. The approximated value is obtained using techniques described herein, such as using a coarse piece-wise linear table lookup.

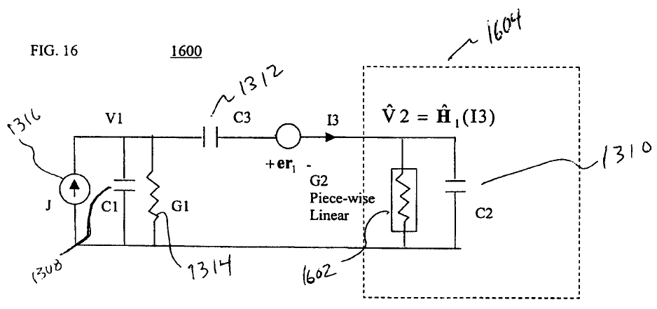

FIG. 16 illustrates the circuit 1300 including a piece-wise linear approximation 1508 of the non-linear element G2. The pre-viewer circuit 1600 is the circuit 1300 including the approximation 1602 in place of the original non-linear element 1302. The partition 1604 replaces the partition 1304 as described in FIGS. 5 and 6.

FIG. 17 is a plot illustrating the accelerated convergence using the pre-viewer circuit 1600. Like the plot 1500, the plot 1700 shows time along the x-axis 1702, and voltage along the y-axis 1704. The voltage in the plot is the error from the actual output generated by the circuit 1300. Note that the scale on the y-axis 1704 is much smaller than the scale on the y-axis 1504, above, indicating that even for the first iteration 1706a, the error is much smaller than the error for the tenth iteration 1506j. By the third iteration 1706c, there is very little error, and the simulation is very close to the actual calculated value for the circuit 1300. The result is that using the embodiments of the invention described herein, the iterations converge much more quickly than without the approximation.

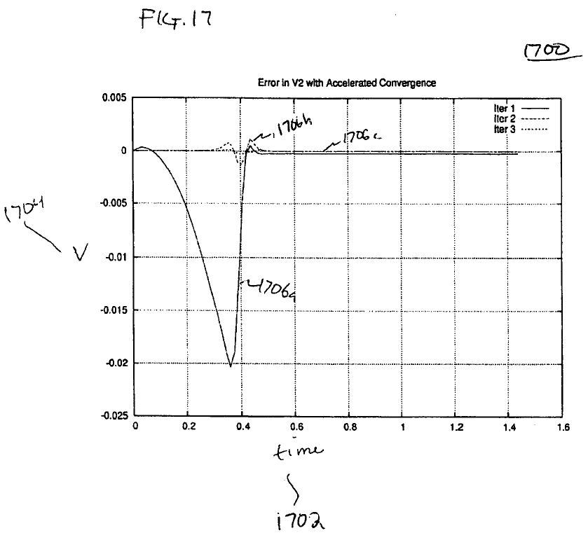

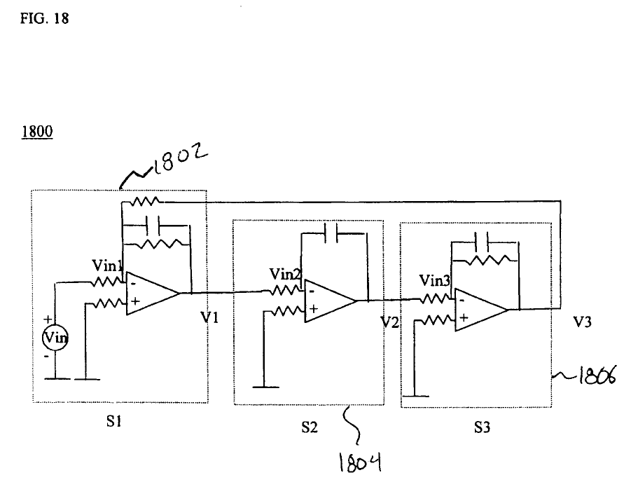

FIGS. 18-22 illustrate uni-directional global and local bi-directional coupling and their simulation according to one embodiment of the invention. FIG. 18 illustrates a bi-quadratic filter circuit 1800. The circuit 1800 includes three operational amplifier stages 1802, 1804, and 1806. The idealized filter transfer function from input voltage to output voltage is second order with an oscillatory response. The actual response has nonlinear effects such as slew rate in operational amplifiers and clamping. In addition, higher order parasitic poles and zeros are present in the linearized transfer function. Considering each operational amplifier stage 1802, 1804, or 1806 as a sub-circuit, it is evident that there is a strong global coupling creating the oscillatory response as one traverses the uni-directional input-output signal flow of the functional blocks. In addition to the global coupling, there is a local bi-directional loading effect at every connecting node. The global coupling is fast acting and strong.

FIG. 19 illustrates the circuit 1800 partitioned using a Gauss-Seidel decomposition. The decomposition 1900 shows the circuit 1800 divided into several ordered partitions 1902, 1904, and 1906. These partitions are made using the known Gauss-Seidel decomposition.

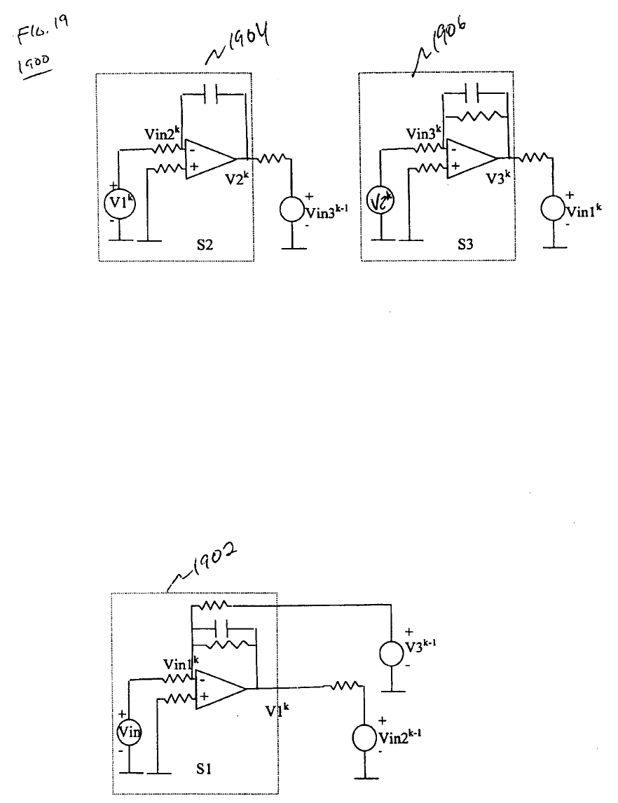

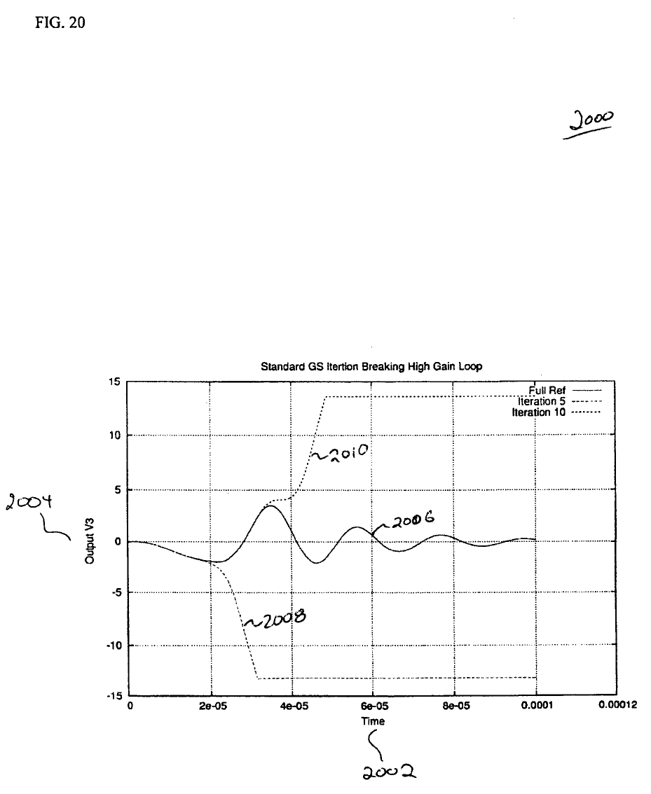

FIG. 20 is a plot showing the convergence of a simulation of the circuit 1800 using the Gauss-Seidel decomposition. The graph 2000 shows time along the x-axis 2002, and voltage along the y-axis 2004. The plot 2006 shows the actual response of the circuit 1800. The plot 2008 shows the output after five iterations using the Gauss-Seidel decomposition 1900. The plot 2010 shows the output after ten iterations using the Gauss-Seidel decomposition 1900. As can be seen, the waveforms are converging very slowly.

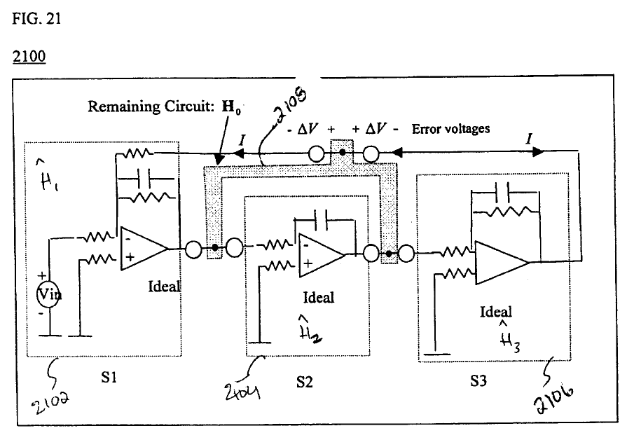

According to an embodiment of the invention, the circuit 1800 can be decomposed in the same manner that the circuit 700 in FIGS. 7, 8, and 9 is decomposed. FIG. 21 illustrates a pre-viewer from decomposition of the circuit 1800 according to an embodiment of the invention. Each sub-circuit stage H₁ 1802, H₂ 1804, and H₃ 1806 is viewed as a non-linear 2-port impedance operator. The remaining circuit H₀ 2108 comprises only nodes with interconnecting wires. Approximation of each stage 2102, 2104, and 2106 is accomplished by replacing the full non-linear operational amplifier by an equivalent ideal voltage controlled voltage source.

FIG. 22 is a graph illustrating the convergence of the circuit 1800 decomposed according to an embodiment of the invention. The graph 2200 displays time on the x-axis 2202, and output voltage on the y-axis 2204. The plot 2206 is the full simulation. The plot 2208 is the output after the first iteration, and the plot 2210 is the output after the second iteration. As can be seen, the simulation converges very quickly when using the decomposition as shown in FIGS. 7, 8, and 9.

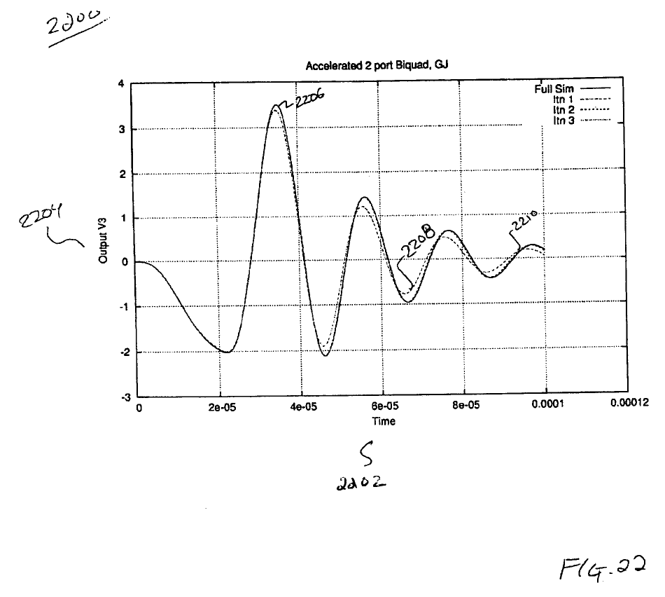

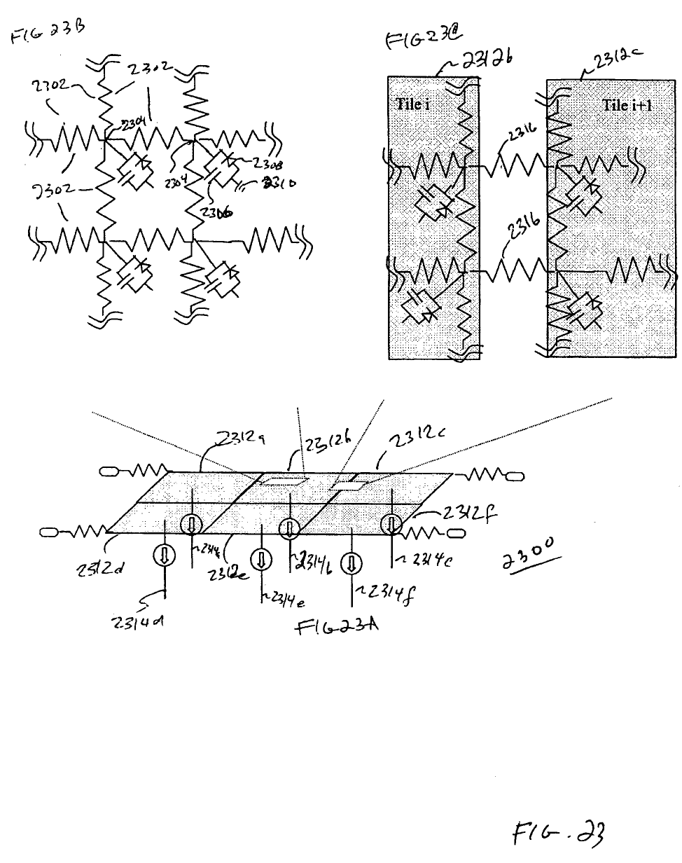

FIGS. 23-26 illustrate a non-linear mesh example of bi-directional local and global coupling according to an embodiment of the invention. FIG. 23A illustrates a non-linear two dimensional mesh 2300. FIGS. 23B and 23C illustrate exploded views of the mesh 2300. The mesh 2300 may be a power grid in an integrated circuit (IC). The mesh 2300 comprises four resistors 2302 at each interior node 2304 connecting to four neighboring nodes. At each node 2304, a capacitor 2306 and a diode 2308 are connected to a ground 2310. The diodes 2308 are reverse biased. The mesh comers are connected to the supply node through the four connecting resistors 2302. The mesh nodes are divided into tiles 2312. As shown in FIG. 23A, the mesh 2300 comprises a grid of 3×2 tiles. Each tile 2312 includes a center node 2304 to which a high impedance current source 2314 is attached.

As shown in FIG. 23C, the tiles 2312 are connected through connecting resistors 2316. These connecting resistors 2316 may constitute the remainder circuit H₀, and each tile 2312 may comprise a partition Hᵢ as in FIGS. 7, 8, and 9. The mesh 2300 can be decomposed in this manner according to an embodiment of the invention.

The approximations Ĥᵢ for the mesh 2300 are made using a reduced order model of the linearized impedance of Hᵢ. The resulting pre-viewer is a low order linear system that can be simulated efficiently.

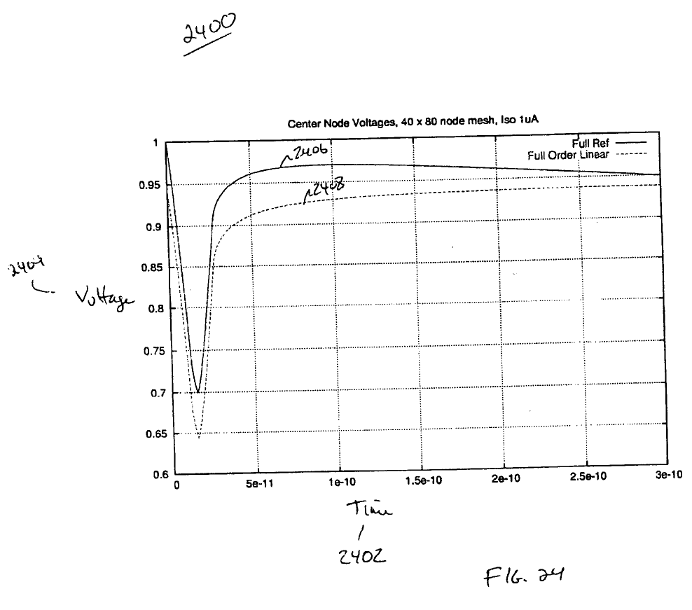

FIG. 24 illustrates a graph 2400 showing a center node voltage for a tile 2312 from a full reference simulation and from a full order linear approximation of the circuit 2300. The x-axis 2402 shows time and the y-axis 2404 show the voltage of the output. The plot 2406 shows the full reference simulation and the plot 2408 shows the full order linear approximation. The difference between the two plots 2406 and 2408 arises from the non-linearity of the diodes 2308.

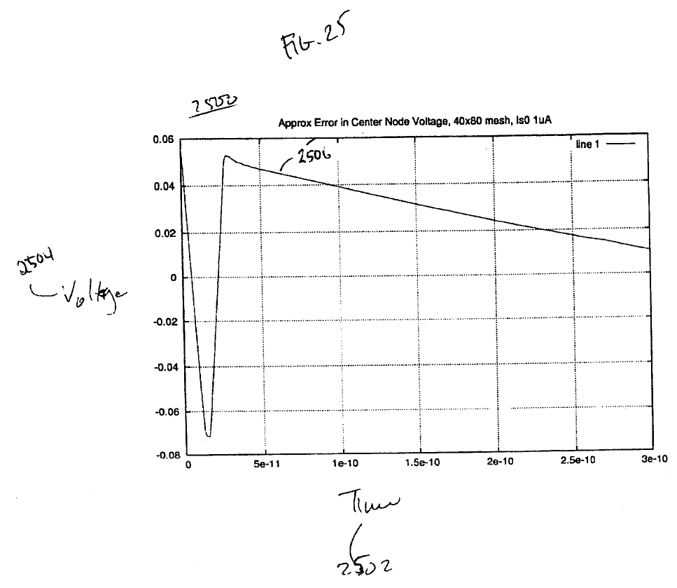

FIG. 25 illustrates the difference between the approximate low order pre-viewer response and the full reference system for a center node voltage of a tile 2312. Again, the x-axis 2502 shows time, and the y-axis 2504 shows voltage. The plot 2506 shows that the difference between the approximation and the full reference is considerable.

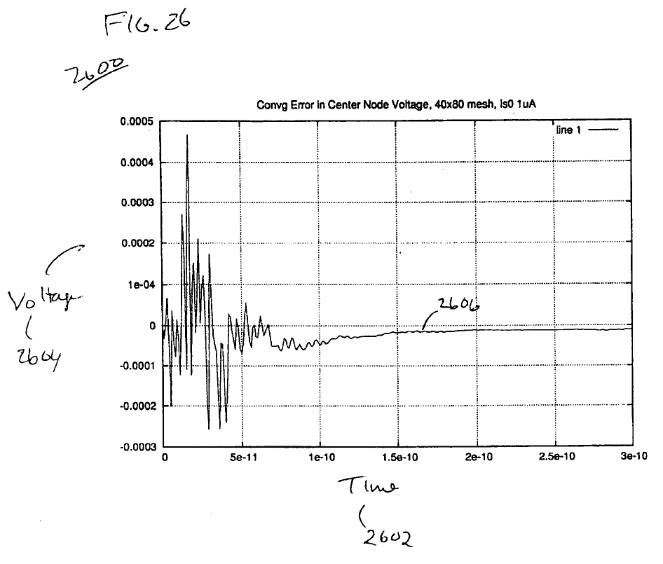

FIG. 26 is a graph showing the error of the voltage output of the simulation after three iterations using an embodiment of pre-viewer based approximation. The graph 2600 includes an x-axis 2602 showing time and a y-axis 2604 showing voltage. The plot 2606 shows that the error is well within accepted tolerances after only three iterations. In contrast, using the standard Gauss-Seidel decomposition, convergence takes over fifty iterations.

### Decomposing the To-Be-Simulated System

As shall be described in greater detail hereafter, each of the partitions produced by partitioner 2704 is separately simulated during the selected partition simulation phase. According to one embodiment, simulation of the selected partitions is performed in parallel. Consequently, the duration of the selected partition simulation phase is dictated by the most-expensive-to-simulate partition that is produced by partitioner 2704.

The smaller/less-complex a partition, the faster it is to simulate the partition. However, as the partitions of a to-be-simulated system become smaller, the number of partitions increases. As the number of partitions increases, so does the overhead associated with coordinating and executing the parallel execution of the simulations.

To determine whether a partition is too large, partitioner 2704 includes a mechanism to determine the “size” of partitions. That mechanism for determining the size of a partition may vary from implementation to implementation based on a variety of factors, including the nature of the to-be-simulated system.

In the context of circuits, for example, partitioner 2704 may be configured to determine the size of a partition of a circuit based, at least in part, on: the number of nodes within the description of the partition, the number of elements represented in the partition, the capabilities of the simulator that will be used to simulate the partition, the amount of volatile memory available to each processor, etc.

The threshold size used to determine whether to further divide a partition may be selected based on a variety of factors, including the estimated amount of time it will take to simulate the pre-viewer circuit, and the desired degree of decomposition of the to-be-simulated system. The desired degree of decomposition may vary, in turn, based on a variety of factors including the number of computer resources available to perform the simulation, the cost of starting a simulator, and the amount of communication overhead that would result from decomposing the system into too many partitions.

According to one embodiment, partitioner 2704 includes a mechanism for estimating the total cost of simulating the to-be-simulated system, based on the computational resources available, the number and size of the partitions into which the system has been divided, the simulators being used, etc. As long as the total simulation cost would be reduced by sub-dividing partitions, partitioner 2704 continues to sub-divide partitions. If the total simulation cost would not be reduced by further sub-dividing partitions, then no further decomposition is performed.

### Multi-Phase Decomposition

According to an embodiment of the invention, partitioner 2704 is configured to partition a system in multiple phases. In general, partitioner 2704 partitions the to-be-simulated system by decomposing the system in a manner that allows for relatively quick convergence (i.e. relatively few simulation iterations), efficient use of the available computing resources, and reduced total computational cost of the simulation.

For the purposes of describing the phases, an example shall be given in which the to-be-simulated system is a circuit. However, the partitioning techniques employed by partitioner 2704 may be applied to any type of to-be-simulated system. The various phases of partitioning shall now be described in greater detail.

### Y/Z Decomposition

According to one embodiment, the first phase of partitioning performed by partitioner 2704 is Y/Z decomposition. During the Y/Z decomposition phase, the partitioner 2704 looks for components, within the to-be-simulated system, that satisfy certain separability criteria. According to one embodiment, the separability criteria include that (1) the components are connected by one or more wires, and (2) if simulated separately, the waveform on the one or more wires would converge.

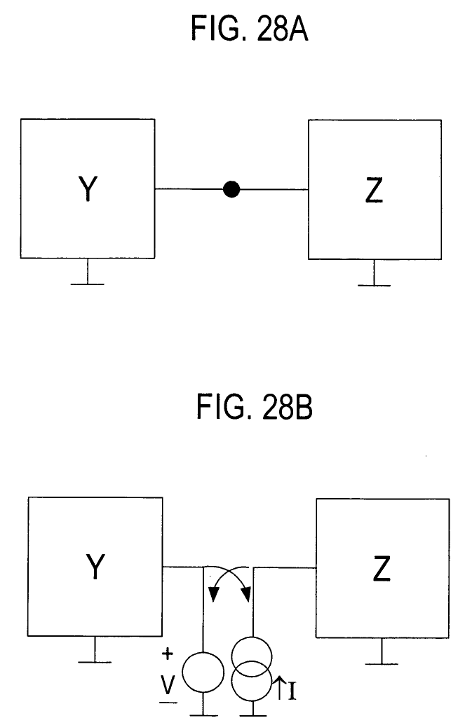

FIG. 28A is a block diagram of two components (Y and Z) that are connected to each other by one or more wires. During the Y/Z decomposition phase, Y and Z are separated into different partitions if convergence would occur by repeatedly performing the following: (1) during a simulation of Y, using the voltage produced by a prior simulation of Z as the input voltage on those wires, and (2) during a simulation of Z, using the current produced by a prior simulation of Y as the input current on those wires. In FIG. 28B, the system that includes components Y and Z has been partitioned by separating Y from Z.

Y/Z decomposition begins by identifying sub-circuits that represent low impedance to ground at the interface nodes. For example, power and ground supply networks in micro-chip circuits represent low impedance to ground at ports connecting them to the active components. The active components supplied by the power and ground networks typically offer low admittance to ground at the ports connecting them to the power and ground networks. Starting with the ground node all nodes that can be reached through a low resistance paths are identified to belong to a Z sub-circuit, provided that other side offer significantly high impedance (or low admittance Y) to ground compared to the impedance to ground offered by the Z sub-circuit.

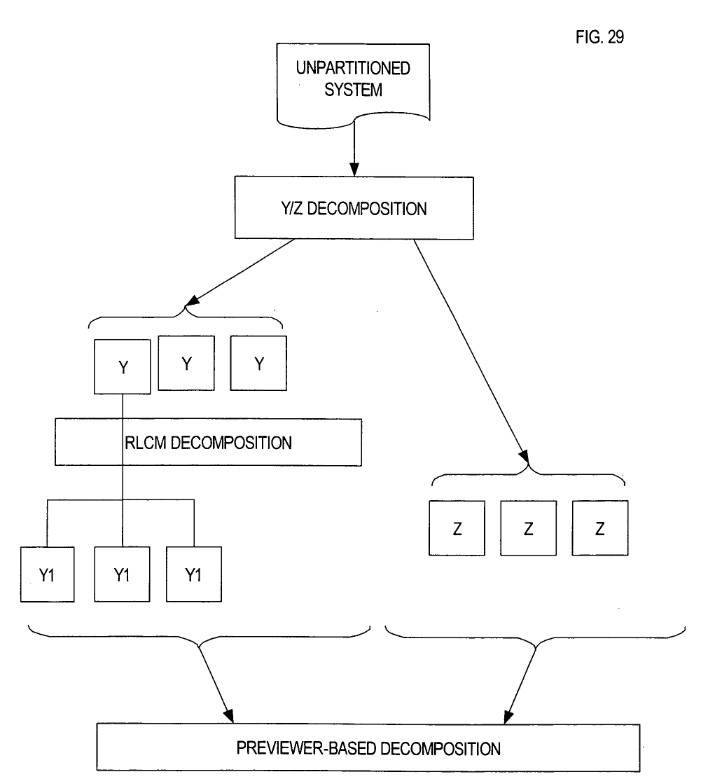

After the Y/Z decomposition phase, the original system may have been partitioned into many partitions, as illustrated in FIG. 29. In FIG. 29, the Y/Z partitioning phase has resulted in partitioning the system into three distinct “Y” partitions, and three distinct “Z” partitions. However, this result is merely exemplary. The specific set of partitions, and the type of those partitions, that result from the Y/Z decomposition phase, will vary based on the nature and characteristics of the to-be-partitioned system.

### RLCM Decomposition

According to one embodiment of the invention, the second phase of the two-phase partitioning operation is referred to herein as RLCM decomposition. RLCM stands for Resistor (R), Inductor (L), Capacitor (C) and MOS Transistor (M). During RLCM decomposition, testing is performed on the partitions produced during the Y/Z decomposition phase to determine if those partitions can be further partitioned.

Each circuit element in the partition is tested to see if it is a candidate for decomposing the partition further into more partitions based upon how strong the coupling offered by the circuit element is. Among all candidate elements, the testing is limited to Resistors, Inductors, Capacitors and MOS transistors. Further, the strength of coupling of the element is computed using Norton Equivalents at the connecting nodes at s=0 (Conuctance Test) and s=infinity (Capacitance Test) (See J. White and A. I. Sangiovanni-Vincentelli, . . . ICAS, 1985 and Relaxation Techniques for the Simulation of VLIS Circuits, 1987), This phase of the decomposition exploits intrinsic properties of the circuit. MOS transistors typically provide unidirectional strong coupling from gate terminal to drain and source terminals. Cycles may form due to global feedback from strong uni-directional flow across partitions. Time windowing (See J. White and A. I. Sangiovanni, ICAS 1985, T. A. Jhonson and A. E. Ruehli, DAC 1992) provides a mechanism for efficient partitions when long loop delays in the cycle are encountered. For short time delays in the cycle are encountered the partitions in the cycle are merged back, resulting in potentially large partitions after the merging.

In the context of circuits, the “Z” partitions produced during the automated Y/Z partitioning typically correspond to power or ground grids. In contrast, the “Y” partitions are typically active non-power-grid structures. According to one embodiment, partitioner 2704 determines whether the Z partitions are power grids, and does not test any power grids thus identified during the RLCM phase, since RLCM testing is unlikely to result in further partitions to power grids.

### Previewer-Based Partitioning

In one embodiment, after the Y/Z decomposition and the RLCM decomposition, any of partitions that continue to exceed a certain threshold size are considered too large, and a further phase of previewer-based decomposition is performed on those partitions.

In general, previewer-based partitioning involves the application of approach described in FIGS. 5 through 12 on each of the large partitions. For each such partition, there is a pre-viewer partition, as in FIGS. 7, 12, 21 and the corresponding sub-partitions as in FIG. 9.

### Generation of Execution Plan

Once the final partitions and sub-partitions are identified, the simulation jobs are created as netlist files. In on embodiment, the netlist files include signals from other simulation jobs as stimuli files. The stimuli files are created by collecting outputs of simulation jobs that have already run, computing the stimuli and writing out the stimuli. In one embodiment, the stimuli are written out as piece-wise linear signals. The execution plan comprises of specification of simulation jobs to be run, and the dependence of one simulation job on output from other simulation jobs. In one embodiment, the execution plan includes a directed acyclic graph to denote the data dependency among simulation jobs.

### Scheduling and Execution of Simulations

In one embodiment, the run-time scheduling of simulations is performed by (1) identifying at any given time, all simulations jobs that are ready to run based on availibity of inputs required to run it, 2) adding simulation jobs that are ready to run in the execution plan to the execution queue and 3) identifying all processors that are available to run with simulation licenses at that time and 4) dispatching the next simulation job in the execution queue to any available processor in step 3). The run-time scheduling loop comprising of steps 1) through 4) is repeated until all simulation jobs in the execution plan have been completed.

### License-Aware Decomposition and Simulation

In some installations, limitations may be imposed on the number of simulators used to perform a simulation. For example, the simulators may be implemented by licensed software, where the license that applies to the simulator software imposes limits on the number of simulators a particular party can use. Therefore, according to one embodiment, such limits are a factor that is taken into account by partitioner 2704 during the decomposition of the to-be-simulated system. For example, partitioner 2704 may limit the number of partitions to ten in response to input that indicates that only ten licensed simulators are available.

According to one embodiment, simulation system 2700 is configured to look for an indication of simulator licenses prior to performing a simulation. System 2700 may be configured, for example, to perform simulations using only simulators for which license indications were discovered. System 2700 may also use the discovered license information as one of the factors used to determine how finely to decompose the to-be-simulated system, as described above.

### Hierarcy-Aware Decomposition and Simulation

In many systems, the elements of the system have hierarchical relationships relative to each other. According to one embodiment, partitioner 2704 takes into account the hierarchical relationships between the elements of a system when determining how to decompose the system. For example, when estimating the cost of further decomposing an existing partition, partitioner 2704 takes into account the hierarchical relationships between the elements in that partition. Subdividing a partition in a manner that splits highly related elements into separate partitions will have a higher cost than subdividing a partition in a manner that splits less related elements into separate partitions.

### Compensating for Erroneous Simulation Results

Unfortunately, simulators do not always produce accurate results. For example, under certain circumstances, when generating data for a series of points, some simulators produce erroneous information for the last point in the series. According to one embodiment, when scheduler 2706 invokes simulators, scheduler 2706 causes the simulators to simulate for a series of points that exceeds the actual desired series of points. When scheduler 2706 receives the simulation results for the requested series of points, scheduler 2706 then discards the unnecessary, and potentially erroneous, simulation results associated with the last point(s) in the requested series.

### Scheduler Look-Ahead

According to one embodiment, scheduler 2706 is designed with a look-ahead feature. For example, when scheduling tasks at a particular level in the execution plan, scheduler 2706 analyzes the execution plan to determine how the currently-to-be-scheduled tasks relate to each other, and how those tasks relate to tasks that need to be scheduled in the future. By looking ahead at portions of the execution plan that relate to future tasks, scheduler 2706 may make intelligent decisions about how to schedule the currently-to-be-scheduled tasks. For example, upon detecting that many future tasks depend on a particular currently-to-be-scheduled task, scheduler 2706 may schedule that particular task ahead of other currently-to-be-scheduled tasks.

### Simulation Progress Reporting

According to one embodiment, scheduler 2706 is configured with a mechanism for reporting the progress of a simulation operation. The scheduler 2706 may be configured, for example, to publish, in some manner, an indication of the progress of the simulation of the entire to-be-simulated system, and/or the progress of the simulations of each selected partition. The manner in which the progress indication is published may vary from implementation to implementation. For example, scheduler 2706 may expose an API that may be called to retrieve the progress indications. Alternatively, scheduler 2706 may generate a visual display of a progress bar. In yet another embodiment, the progress may be visually represented by changing the color of a displayed element.

### Intermediate Results Reporting

According to one embodiment, scheduler 2706 is configured with a mechanism for reporting preliminary simulation results prior to completion of the entire simulation operation. For example, the scheduler 2706 may expose an API that may be called to retrieve the simulation results produced by the most recent simulation iteration. Those results may be provided for the system as a whole, or on a partition-by-partition basis.

According to one embodiment, scheduler 2706 generates information that (1) identifies the portion of the system that is represented by a selected partition, and (2) the most recent simulation results produced by simulating that selected partition. Even though the simulation of the entire system may be ongoing, it is possible that the simulation results for the particular partition are “final” because the results of simulating that partition have converged with the results of simulating the pre-viewer circuit.

### To-Be-Simulated Systems

The techniques described herein may be used to any system, as long as the results of the previewer-phase simulation and the selected partition-phase simulations will converge. Thus, while many of the examples given herein are in the context of circuit simulation, these same techniques may be used to parallelize simulation in any number of contexts, including but not limited to: airplane/airframe simulation, oil field simulation, refining/chemical simulation, business/stock market simulation, medical imaging, computer animation, meteorology, biotech simulation, machine simulation, architecture simulation, micro-mechanical simulation (MEMS), optical system simulation, video encoding and/or encryption, and power distribution simulation.

### Multi-Mode Systems

In the examples given above, the to-be-simulated systems primarily involve one type of technology. For example, a to-be-simulated system may be an analog circuit, or an RF circuit. However, the techniques described herein may be similarly applied to simulate systems that include different types of subsystems. For example, the techniques may be used to simulate a system that includes two or more sub-systems that use different technologies, and therefore require different simulators. For example, the techniques may be used to simulate a system that contains RF circuitry interfacing with analog circuitry interfacing with digital circuitry, etc. Such systems are referred to herein as “multi-mode” systems.

When used to simulate a multi-mode system, the first round of partitioning may involve dividing the system up based on the simulators that will have to be used to simulate the different sub-systems of the system. When the sub-systems are tightly coupled, a previewer based partitioning is used at this level. The partitions created in this manner may be further subdivided to achieve the desired degree of decomposition. Data interchange between partition simulations can be done using just simulation waveforms. Therefore, use of a simulators with completely different simulation mechanism is allowed. Simulators specialized for a particular class of circuitry, can provide significantly higher speeds than a generic simulator.

### Multi-Core CPUS

Multi-core CPUs have multiple processing units on a single die. The overhead associated with communications between cores on the same die is significantly less than the overhead associated with communications between processors on different dies. According to an embodiment, this difference is one of the factors that is taken account during the decomposition of the to-be-simulated system, and during the scheduling of the simulations.

For example, in response to detecting the presence of multi-core CPUs, a circuit may be decomposed to create separate groups of partitions that require relatively more communications among the partition in the group. During the simulation, the partitions in a group is assigned to the same multi-core CPU. In one embodiment, cost metric used in partitioning includes relative communication loads between simulation partitions.

### Integrated Simulators

In one embodiment, simulators 2708 are invoked by scheduler 2706 every time a new simulation operation needs to be performed. Unfortunately, frequently starting up a simulator may result in a significant amount of overhead, especially to simulate a relatively small partition. The overhead includes reading and parsing the information that defines the partition that is to be simulated.

According to one embodiment, simulators 2708 are integrated into system 2700, and are designed to remain allocated between simulation operations. Thus, during the first simulation iteration of a partition, a simulator may read and parse a net-list that defines the partition. After the first iteration, the parsed information about the net-list is retained. Consequently, when the simulator performs a subsequent simulation iteration of the same partition, the net-list need not be reparsed.

In one embodiment, the previewer approximation is computed from the parsed net-list by the simulator. The integrated simulator can store the computed approximation from the first run and use it in subsequent simulation iterations of the previewer.

### Creating and Propagating Ancillary Information

The input needs of simulators vary from simulator to simulator. Some simulators are able to operate more efficiently when provided with information above and beyond the definition of the to-be-simulated system. Such information is referred to herein as “ancillary” information.

An example of ancillary information is information about the hierarchy between elements in a circuit. Some circuit simulators may use such hierarchy information to more efficiently simulate a circuit. According to one embodiment, such hierarchy information is provided as input to system 2700. When the to-be-simulated system is decomposed by system 2700, the hierarchy information associated with each partition is identified, and is provided to the simulator that is responsible for simulating the partition.

According to another embodiment, the hierarchy information is derived by system 2700 based on the definition of the to-be-simulated system. Thus, even though the hierarchy information is not provided to system 2700, the hierarchy information may be provided to the simulators to improve the efficiency of the simulations.

In one embodiment, the system 2700 “flattens” hierarchical that describes the to-be-simulated system in order to facilitate decomposition of the to-be-simulated system. However, system 2700 retains information about the hierarchy, so that such information may be provided to the simulators that make use of such information.

Hierarchy information is merely one example of ancillary information that a simulator may be able to use to perform simulations more efficiency. According to one embodiment, system 2700 causes the portion of the ancillary information that applies to each partition to be provided to the simulator that is assigned the task of performing the simulation of that partition.

### Parallelization in Other Contexts

The parallelization techniques described herein have been described in the context of simulation operations. However, these techniques may be applied in a similar manner in other contexts. For example, the deconstruction/parallelization techniques described herein may be applied to microchip design operations.

### Single CPU Platform

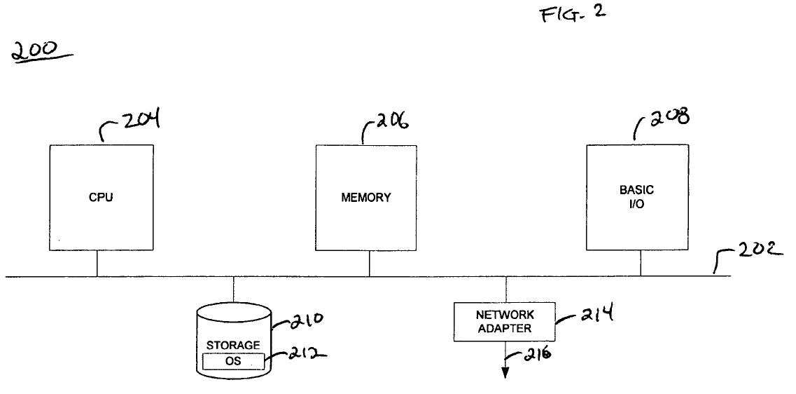

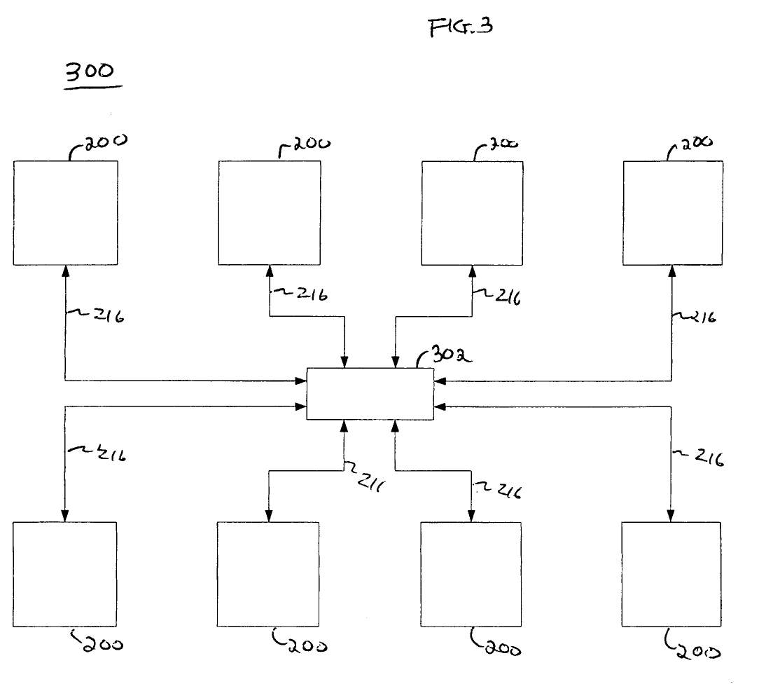

FIG. 2 illustrates a computer system on which an embodiment of the present invention can be implemented. The computer system 200 may be part of a larger cluster that will be described in FIG. 3. The computer system 200 includes a bus 202, which serves as a distribution channel for information throughout the computer system 200. A processor 204 is coupled to the bus 202. The processor 204 may be any suitable processor, including but not limited to those manufactured by Intel and Motorola. The processor 204 may also comprise multiple processors. A memory 206 is also coupled to the bus 202. The memory 206 may include random access memory (RAM), read only memory (ROM), flash memory, etc. A basic Input/Output unit 208 receives input from several sources such as keyboards, mice, etc., and outputs to output devices such as displays, speakers, etc. Storage 210 may include any type of permanent or transient storage including magnetic or optical storage such as hard drives or compact disc-read only memories (CD-ROM). A copy of an operating system (OS) 212 may be stored on the storage 210. The OS 212 includes the software necessary to operate the computer system 200, and may be a Unix derivative such as Linux, etc. It is understood that the OS 212 may also be any other available OS, such as Microsoft Windows or the Macintosh OS. A network adapter 214 connects the computer system 200 with other systems in a cluster, and with other networks such as the Internet through a connection 216. It is understood that the computer system 200 is only an example of computer systems that may be used to implement the invention, and that any other appropriate configuration may be used.

### Cluster Platform Environment

FIG. 3 illustrates a cluster of computer systems 300 according to an embodiment of the invention. Several computer systems 200 may be networked together using a peer-to-peer arrangement with a central switch or a router 302. Alternatively, one of the computer systems 200 in the networked system 300 may be a central server. Using this implementation, several inexpensive computer systems 200 can be networked into a cluster 300 to provide a powerful system through which parallelized problems can be solved.

It is understood that the embodiments of the current invention are not limited to circuit simulations. For example, several other types of simulations, such as chemical simulations, biological simulations, automotive simulations, etc. may be performed using the systems and techniques described herein. These techniques can be adapted for a specific application.

Various techniques have been described with reference to specific exemplary embodiments. It will, however, be evident to persons having the benefit of this disclosure that various modifications changes may be made to these embodiments without departing from the broader spirit and scope of the invention. The specification and drawings are accordingly to be regarded in an illustrative rather than in a restrictive sense.

1. A method for simulating a system, the method comprising:
automatically decomposing the system into a first set of partitions based on one or more estimated costs associated with simulating the system;
performing a simulation of the system, where the portions of the system that correspond to the first set of partitions are simulated using a relatively less-precise simulation mechanism; and
performing a second set of simulations during which each partition in the first set of partitions is simulated using a relatively more-precise simulation mechanism.

2. The method of claim 1 further comprising:
monitoring performance of said second set of simulations;
in response to detecting that performance of one or more of the second set of simulations deviates from the one or more estimated costs by more than a predetermined amount, performing the steps of:
further decomposing the system to produce a second set of partitions;
performing a simulation of the system, where the portions of the system that correspond to the second set of partitions are simulated using a relatively less-precise simulation mechanism; and
performing a third set of simulations during which each partition in the second set of partitions is simulated using a relatively more-precise simulation mechanism.

3. The method of claim 1 wherein the step of automatically decomposing is performed based, at least in part, on licensing information related to simulators that are to be used to simulate the system.

4. A method for simulating a system, the method comprising:
decomposing the system into a plurality of partitions;
wherein a first set of the partitions correspond to a first type of technology that can be simulated on a first type of simulator but not on a second type of simulator;
wherein a second set of the partitions correspond to a second type of technology that can be simulated on the second type of simulator but not the first type of simulator;
simulating the system by performing steps that include
simulating each partition in the first set of partitions using the first type of simulator; and
simulating each partition in the second set of partitions using the second type of simulator.

5. The method of claim 4 wherein the step of simulating the system includes:
performing a simulation of the system, where the portions of the system that correspond to the plurality of partitions are simulated using a relatively less-precise simulation mechanism; and
performing a second set of simulations during which each partition in the plurality of partitions is simulated using a relatively more-precise simulation mechanism;
wherein the step of performing the second set of simulations includes
simulating each partition in the first set of partitions using the first type of simulator; and
simulating each partition in the second set of partitions using the second type of simulator.

6. A method for simulating a system, the method comprising:
automatically detecting licensing information related to simulators that are to be used to simulate the system; and
simulating the system based, at least in part, on said licensing information.

7. The method of claim 6 wherein the step of simulating the system based, at least in part, on said licensing information includes:
automatically decomposing the system into partitions based, at least in part, on licensing information related to simulators that are to be used to simulate the system; and
using the partitions to simulate the system.

8. A computer-readable medium carrying one or more sequences of instructions which, when executed by one or more processors, causes the one or more processors to perform the method recited in claim 1.

9. A computer-readable medium carrying one or more sequences of instructions which, when executed by one or more processors, causes the one or more processors to perform the method recited in claim 2.

10. A computer-readable medium carrying one or more sequences of instructions which, when executed by one or more processors, causes the one or more processors to perform the method recited in claim 3.

11. A computer-readable medium carrying one or more sequences of instructions which, when executed by one or more processors, causes the one or more processors to perform the method recited in claim 4.

12. A computer-readable medium carrying one or more sequences of instructions which, when executed by one or more processors, causes the one or more processors to perform the method recited in claim 5.

13. A computer-readable medium carrying one or more sequences of instructions which, when executed by one or more processors, causes the one or more processors to perform the method recited in claim 6.

14. A computer-readable medium carrying one or more sequences of instructions which, when executed by one or more processors, causes the one or more processors to perform the method recited in claim 7.
